(19) United States
(12) Patent Application Publication
(10) Pub. No.: US 2025/0121879 A1
(43) Pub. Date: Apr. 17, 2025

(54) ROTATION-LIMITING DEVICE AND STEERING DEVICE

(71) Applicant: NSK STEERING & CONTROL, INC., Tokyo (JP)

(72) Inventor: Kazuyuki HATANAKA, Gunma (JP)

(73) Assignee: NSK STEERING & CONTROL, INC., Tokyo (JP)

(21) Appl. No.: 18/834,769

(22) PCT Filed: Dec. 20, 2022
(86) PCT No.: PCT/JP2022/046981

§ 371 Date: Jul. 31, 2024

(30) Foreign Application Priority Data
Feb. 3, 2022 (JP) 2022-015858
Apr. 8, 2022 (JP) 2022-064765

(51) Int. Cl. B62D 5/04; B62D 1/16

(52) U.S. Cl. CPC B62D 5/0475; B62D 1/16

(57) ABSTRACT

A rotation limiting device including: a first member having a first protrusion; a second member having a second protrusion disposed on an axial one side with respect to the first protrusion, the second member being disposed coaxially with the first member and configured to rotate relative to the first member; and at least one intermediate member supported in a relatively rotatable manner with respect to the first member and the second member, the intermediate member including a side plate portion disposed between the first protrusion and the second protrusion in an axial direction, an intermediate side first protrusion protruding toward an axial other side from an axial other side surface of the side plate portion, and an intermediate side second protrusion protruding toward the axial one side from an axial one side surface of the side plate portion.

### TECHNICAL FIELD

The present disclosure relates to a rotation limiting device for limiting a rotatable amount of a rotation member, and a steering device.

### BACKGROUND ART

In a rack-and-pinion type steering device, when a steering wheel is operated (turned) to the maximum limit to the right or left, a rack end, which is supported and fixed to an end portion of a rack shaft collides with a housing. As described above, in the rack-and-pinion type steering device in which a steering unit and a steered unit are mechanically connected, by limiting the stroke of a rack shaft constituting the steered unit, the number of lock-to-lock turns of the steering wheel (the number of turns of the steering wheel when the steering wheel is operated from fully right or left to fully left or right) is limited.

On the other hand, in a steer-by-wire type steering device, the steering unit and the steered unit are not mechanically connected. Therefore, the number of lock-to-lock turns of the steering wheel constituting the steering unit cannot be limited by limiting the stroke of the rack shaft constituting the steered unit.

FIG. 20 shows a stopper unit 100 for mechanically limiting the number of lock-to-lock turns of a steering wheel in a steer-by-wire type steering device described in Patent Literature 1. FIG. 20 shows FIG. 4 of Patent Literature 1 with the left and right reversed (left and right symmetric). The stopper unit 100 includes a first rotation member 101, a housing 102, and a second rotation member 103.

The first rotation member 101 has a first rotation protrusion 104 protruding toward an axial one side on an axial one side surface (left side surface in FIG. 20). The first rotation member 101 is coupled and fixed to a tip end portion (end portion on an axial other side) of a steering shaft (not shown) in a manner of not be rotatable relative to the tip end portion. That is, the first rotation member 101 rotates integrally with the steering shaft in response to operation of the steering wheel.

The housing 102 has a fixing protrusion 105 protruding toward an axial other side on an axial other side surface (right side surface in FIG. 20), and does not rotate even during use. The steering shaft is supported on a radially inner side of the housing 102 so as to be rotatable relative to the housing 102.

The second rotation member 103 includes a cylindrical portion 106 and a second rotation protrusion 107 protruding toward a radially outer side from a position in a circumferential direction of an outer peripheral surface of the cylindrical portion 106. The second rotation member 103 is supported around the steering shaft so as to be rotatable relative to the steering shaft, the first rotation member 101, and the housing 102.

That is, the steering shaft is inserted through the housing 102 and the second rotation member 103 from the axial one side toward the axial other side, and the first rotation member 101 is coupled and fixed to the tip end portion of the steering shaft that protrudes from an end surface on the axial other side of the second rotation member 103. The steering wheel is supported and fixed to an end portion on the axial one side of the steering shaft.

In the steering device including the stopper unit 100, for example, when the steering wheel is operated to the right (turned in a clockwise direction as viewed from the left side in FIG. 20), first, the first rotation member 101 rotates together with the steering shaft from an upper side toward a lower side in FIG. 20. Then, a circumferential one side surface (a lower side surface in FIG. 20) of the first rotation protrusion 104 collides with a circumferential other side surface (an upper side surface in FIG. 20) of an axial other side portion of the second rotation protrusion 107.

When the steering wheel is further turned to the right from this state, the second rotation member 103 rotates together with the steering shaft and the first rotation member 101 from the upper side toward the lower side in FIG. 20. Then, a circumferential one side surface of an axial one side portion of the second rotation protrusion 107 comes into contact with a circumferential other side surface of the fixing protrusion 105. Thus, the steering wheel is restricted from being operated further to the right.

Patent Literature 2 discloses a small and lightweight multi-rotation limit mechanism that aims to detect a rotation limit operation with high accuracy without using a reduction gear mechanism. The multi-rotation limit mechanism includes: a rotation shaft rotatably provided on a bearing plate and having a rotation stopper fixed thereto; a plurality of idle rotors that are loosely fitted to the rotation shaft to receive rotation from the rotation stopper; a stopper rotor which is loosely fitted to the rotation shaft and to be engaged with the idle rotors; a pair of spring members which bias a stopper portion of the stopper rotor in both rotation directions; an electric sensor for detecting the stopper portion; and engaging pieces provided on the rotation stopper, the idle rotor, and the stopper rotor and to be engaged with each other.

Patent Literature 3 discloses a steering device that aims to keep constant a position of a striking sound generated when an operating member is rotated from a neutral position to the left or right. The steering device rotatably holds the operating member that is not mechanically connected to a steered wheel. The steering device includes: a shaft member that rotates in response to an operation of an operating member; a holding member that rotatably holds the shaft member; a rotation engagement member that is attached to the shaft member and includes a rotation claw that rotates integrally with the shaft member; a fixed claw that is disposed at a position not engaged with the rotation claw and is fixed to the holding member; an intermediate engaging member that rotates about an axis of the shaft member by engaging with the rotation engagement member and includes an intermediate claw that engages with the rotation claw and the fixed claw in a circumferential direction; and a biasing member that applies a biasing force to maintain the intermediate claw at a predetermined position in the circumferential direction with respect to the fixed claw in a state not engaged with the rotation claw.

Patent Literature 4 discloses a steer-by-wire type power steering device. The power steering device is provided with a rotation restriction mechanism that restricts a steering angle range of a steering wheel. The rotation restriction mechanism includes an integrated rotation portion that rotates integrally with a second input shaft, a relative rotation portion that rotates relative to the integrated rotation portion, and a stopper mechanism that restricts rotation of the relative rotation portion.

Patent Literature 5 discloses a steer-by-wire type steering device. The steering device includes: a first rotation member that is coupled to a steering shaft and rotates in conjunction with the steering shaft; a second rotation member that is supported on an outer periphery of the first rotation member and rotates in conjunction with the first rotation member when the steering shaft rotates; and a housing that houses the first rotation member and the second rotation member therein, is coupled to a steering column, and restricts rotation of the second rotation member by supporting an outer peripheral surface of the second rotation member on an inner peripheral surface.

### CITATION LIST

### Patent Literature

Patent Literature 1: JP2020-69844A

Patent Literature 2: JPH05-042437A

Patent Literature 3: JP2021-172231A

Patent Literature 4: JP2006-182078A

Patent Literature 5: US20220266895

### SUMMARY OF INVENTION

### Technical Problem

In the stopper unit 100 described in Patent Literature 1, the angle at which the first rotation member 101 can rotate with respect to the second rotation member 103 is smaller than 360 degrees by the sum of a circumferential width of the first rotation protrusion 104 and a circumferential width of the second rotation protrusion 107. The angle at which the second rotation member 103 can rotate with respect to the housing 102 is smaller than 360 degrees by the sum of a circumferential width of the fixing protrusion 105 and the circumferential width of the second rotation protrusion 107. Therefore, in the steering device including the stopper unit 100, the rotatable amount (rotatable angle) of the steering shaft is limited to less than ±360 degrees. The same also applies to the techniques of Patent Literatures 3 to 5. Accordingly, the number of lock-to-lock turns of the steering wheel is limited to less than two turns.

However, in a steering device for typical passenger cars that have become widespread in recent years, the number of lock-to-lock turns is greater than two turns. For example, in a so-called family car, the number of lock-to-lock turns is about four turns, and even in a sports car, the number of lock-to-lock turns is about two to three turns. Therefore, a rotation limiting device that allows a high degree of freedom in setting the number of lock-to-lock turns of the steering wheel is desired.

The multi-rotation limit mechanism of Patent Literature 2 is a device for detecting a rotational end of a rotation shaft, and does not lock the rotation of the rotation shaft.

In view of the above-described circumstances, an object of the present disclosure is to provide a rotation limiting device having a high degree of freedom in setting a rotatable amount of a rotation member.

### Solution to Problem

A rotation limiting device according to a first aspect of the present disclosure includes a first member, a second member, and at least one intermediate member.

The first member has a first protrusion.

The second member has a second protrusion disposed on an axial one side with respect to the first protrusion. The second member is disposed coaxially with the first member and configured to rotate relative to the first member.

The at least one intermediate member includes a side plate portion disposed between the first protrusion and the second protrusion in an axial direction, an intermediate side first protrusion protruding toward an axial other side from an axial other side surface of the side plate portion, and an intermediate side second protrusion protruding toward the axial one side from an axial one side surface of the side plate portion. The at least one intermediate member is supported in a relatively rotatable manner with respect to the first member and the second member.

A rotation limiting device according to a second aspect of the present disclosure is directed to the rotation limiting device according to the first aspect, in which the first member may have a first side surface facing the axial one side and the first protrusion protruding from the first side surface toward the axial one side, and the second member may have a second side surface facing the axial other side and the second protrusion protruding from the second side surface toward the axial other side.

A rotation limiting device according to a third aspect of the present disclosure is directed to the rotation limiting device according to the first aspect, in which the first member may be fitted radially inside the second member in a relatively rotatable manner, and the at least one intermediate member may be disposed between the first member and the second member in a radial direction and be rotatable relative to the first member and the second member. The rotation limiting device according to the third aspect may be implemented together with the rotation limiting device according to the second aspect.

A rotation limiting device according to a fourth aspect of the present disclosure is directed to the rotation limiting device according to the third aspect, in which the second member may include a second cylindrical portion disposed on a radially outer side of the first member and the at least one intermediate member.

A rotation limiting device according to a fifth aspect of the present disclosure is directed to the rotation limiting device according to the fourth aspect, in which the first member may have a first side surface facing the axial one side and the first protrusion protruding from the first side surface toward the axial one side, the second member may have a second side surface facing the axial other side and the second protrusion protruding from the second side surface toward the axial other side, the second member may have a second flange portion bent toward a radially inner side from an end portion of the second cylindrical portion on the axial one side, and the second flange portion may have the second side surface on an axial other side surface.

A rotation limiting device according to a sixth aspect of the present disclosure is directed to the rotation limiting device according to the fifth aspect, in which the second member may include a housing body having the second cylindrical portion and the second flange portion, and a lid body covering a radially outer side portion of an opening portion of the second cylindrical portion on the axial other side.

A rotation limiting device according to a seventh aspect of the present disclosure is directed to the rotation limiting device according to the sixth aspect, in which the housing body may have a body side coupling hole, and the lid body may have a lid side coupling hole. In this case, one coupling hole of the body side coupling hole and the lid side coupling hole is a screw hole, and the other coupling hole of the body side coupling hole and the lid side coupling hole is a screw hole or a cylindrical hole. Further, the rotation limiting device includes a coupling bolt to be screwed or inserted into the other coupling hole and screwed into the one coupling hole.

A rotation limiting device according to an eighth aspect of the present disclosure is directed to the rotation limiting device according to the fourth aspect, in which the first member may have a first side surface facing the axial one side and the first protrusion protruding from the first side surface toward the axial one side, the second member may have a second side surface facing the axial other side and the second protrusion protruding from the second side surface toward the axial other side, and the second member may include a housing body including the second cylindrical portion and an inward flange portion bent toward a radially inner side from an end portion of the second cylindrical portion on the axial other side, and a lid body covering a radially outer side portion of an opening portion of the second cylindrical portion on the axial one side. In this case, the lid body has the second side surface on an axial other side surface.

A rotation limiting device according to a ninth aspect of the present disclosure is directed to the rotation limiting device according to the eighth aspect, in which the housing body may have a body side coupling hole, and the lid body may have a lid side coupling hole. In this case, one coupling hole of the body side coupling hole and the lid side coupling hole is a screw hole, and the other coupling hole of the body side coupling hole and the lid side coupling hole is a screw hole or a cylindrical hole. Further, the rotation limiting device includes a coupling bolt to be screwed or inserted into the other coupling hole and screwed into the one coupling hole.

A rotation limiting device according to a tenth aspect of the present disclosure is directed to the rotation limiting device according to the second aspect, in which the first member may include a first cylindrical portion to which the at least one intermediate member is externally fitted in a relatively rotatable manner, and a first flange portion that protrudes toward a radially outer side from an outer peripheral surface of the first cylindrical portion. In this case, the first flange portion has the first side surface on an axial one side surface. The rotation limiting device according to the tenth aspect may be implemented together with the rotation limiting device according to any one of the third aspect to ninth aspect.

A rotation limiting device according to an eleventh aspect of the present disclosure is directed to the rotation limiting device according to the first aspect, and may include a preload applying member configured to apply a preload in the axial direction between the first member and the second member. The rotation limiting device according to the device aspect may be implemented together with the rotation limiting device according to any one of the second aspect to tenth aspect.

A steering device according to a twelfth aspect of the present disclosure includes: a steering shaft; and a rotation limiting device configured to limit a rotatable amount of the steering shaft to a predetermined value.

The rotation limiting device is implemented by the rotation limiting device according to any one of the first aspect to eleventh aspect.

One member of the first member and the second member is coupled and fixed to the steering shaft, and the other member of the first member and the second member is supported and fixed to a portion that does not rotate even during use.

### Advantageous Effects of Invention

According to the rotation limiting device of an aspect of the present disclosure, it is possible to improve the degree of freedom in setting a rotatable amount of a rotation member.

### BRIEF DESCRIPTION OF DRAWINGS

FIG. 1 is a schematic view showing an example of a steer-by-wire type steering device including a rotation limiting device according to a first example of an embodiment of the present disclosure.

FIG. 2 is a cross-sectional view showing the rotation limiting device according to the first example of the embodiment of the present disclosure.

FIG. 3 is an exploded perspective view showing the rotation limiting device according to the first example of the embodiment of the present disclosure.

(A) to (C) of FIG. 4 are schematic views illustrating an operation of the rotation limiting device when a steering wheel is operated from fully left to fully right.

(A) to (C) of FIG. 5 are schematic views illustrating an operation of the rotation limiting device when the steering wheel is operated from fully right to fully left.

FIG. 6 is a cross-sectional view showing a modification of the first example of the embodiment of the present disclosure.

(A) to (D) of FIG. 7 are schematic views illustrating an operation of a rotation limiting device when a steering wheel is operated from fully left to fully right according to the modification.

(A) to (D) of FIG. 8 are schematic views illustrating an operation of a rotation limiting device when a steering wheel is operated from fully right to fully left according to the modification.

FIG. 9 is a cross-sectional view showing a rotation limiting device according to a second example of the embodiment of the present disclosure.

FIG. 10 is a cross-sectional view showing a rotation limiting device according to a third example of the embodiment of the present disclosure.

FIG. 11 is a cross-sectional view showing a rotation limiting device according to a fourth example of the embodiment of the present disclosure.

FIG. 12 is a cross-sectional view showing a rotation limiting device according to a fifth example of the embodiment of the present disclosure.

FIG. 13 is an exploded perspective view showing the rotation limiting device according to the fifth example of the embodiment of the present disclosure.

FIG. 14 is a cross-sectional view showing a rotation limiting device according to a sixth example of the embodiment of the present disclosure.

FIG. 15 is an exploded perspective view showing the rotation limiting device according to the sixth example of the embodiment of the present disclosure.

FIG. 16 is a cross-sectional view showing a rotation limiting device according to a seventh example of the embodiment of the present disclosure.

FIG. 17 is an exploded perspective view showing the rotation limiting device according to the seventh example of the embodiment of the present disclosure.

FIG. 18 is a cross-sectional view showing a rotation limiting device according to an eighth example of the embodiment of the present disclosure.

FIG. 19 is an exploded perspective view showing the rotation limiting device according to the eighth example of the embodiment of the present disclosure.

FIG. 20 is an exploded view showing a stopper unit in the related art.

### DESCRIPTION OF EMBODIMENTS

### First Example of Embodiment

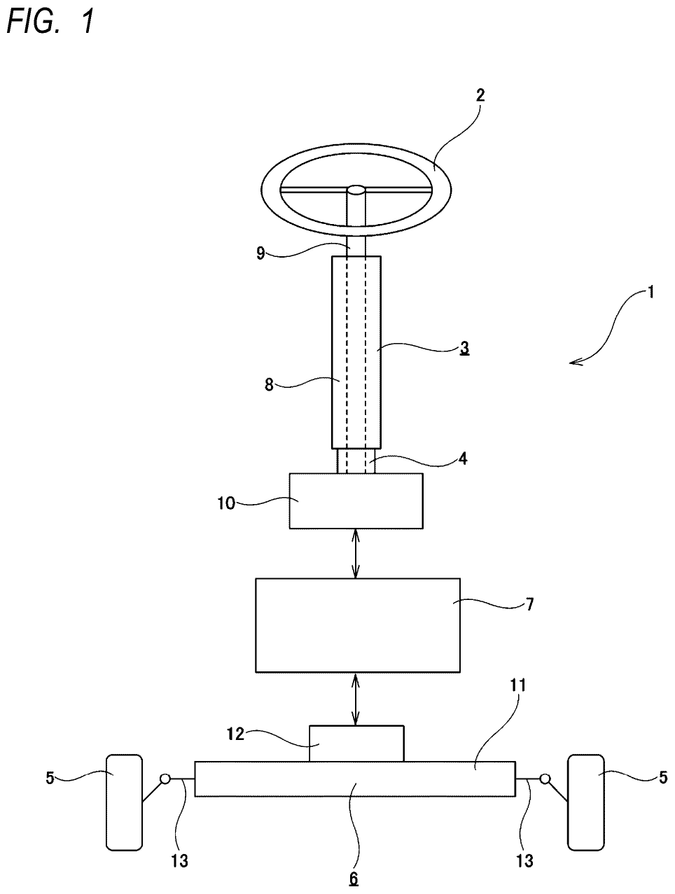

A first example of an embodiment of the present disclosure will be described with reference to FIG. 1 to (C) of FIG. 5. This example is an example in which a rotation limiting device 4 is incorporated in a steering unit 3 constituting the steering device 1 in order to limit the number of lock-to-lock turns of a steering wheel 2 of a steer-by-wire type steering device 1. Hereinafter, first, an overall structure of the steering device 1 will be described, and then a structure and operation of the rotation limiting device 4 will be described. In the following description, a front-rear direction means a front-rear direction of the vehicle.

### <Overall Structure of Steering Device 1>

As shown in FIG. 1, the steering device 1 includes the steering unit 3 including the steering wheel 2, a steered unit 6 that applies a steering angle to a pair of steered wheels 5, and a control unit (ECU) 7. The steering device 1 has a linkless structure in which the steering unit 3 and the steered unit 6 are not mechanically connected to each other, but are electrically connected to each other via the control unit 7.

The steering unit 3 includes a steering column 8, a steering shaft 9, a reaction force applying device 10, and the rotation limiting device 4.

The steering column 8 has a tubular shape and is supported on a vehicle body.

The steering shaft 9 is rotatably supported on a radially inner side of the steering column 8. The steering wheel 2 is supported and fixed to an end portion of the steering shaft 9 on a rear side.

The reaction force applying device 10 is connected to an end portion of the steering shaft 9 on a front side. The reaction force applying device 10 includes a reaction force applying motor and a reducer such as a worm gear reducer, and increases the output torque of the reaction force applying motor by the reducer and then applies it to the steering shaft 9.

The rotation limiting device 4 is provided between the steering shaft 9 and a portion that does not rotate even during use, and limits the number of lock-to-lock turns of the steering wheel 2. In this example, the rotation limiting device 4 is provided between a front portion of the steering shaft 9 and an end portion of the steering column 8 on the front side. The rotation limiting device 4 can be provided at any position as long as the rotation limiting device 4 is between the steering shaft 9 and a fixed portion that does not rotate even during use. Specifically, the rotation limiting device 4 may also be provided in a portion closer to the steering wheel 2, for example, between a rear portion of the steering shaft 9 and a rear end portion of the steering column 8. Alternatively, the rotation limiting device 4 may be provided between the end portion of the steering shaft 9 on the front side and a housing of the reaction force applying device 10. When the rotation limiting device 4 is disposed between the end portion of the steering shaft 9 on the front side and the housing of the reaction force applying device 10, the rotation limiting device 4 can be relatively easily attached or detached. A specific configuration of the rotation limiting device 4 will be described later.

The steering unit 3 further includes a sensor such as a torque sensor or a steering angle sensor that measures an operation of the steering wheel 2 by a driver.

The steered unit 6 includes a gear housing 11 that is supported and fixed to the vehicle body, a linear motion member, and a steering actuator 12 that linearly drives the linear motion member.

The linear motion member is implemented by a rack shaft, a screw shaft, and the like. The linear motion member has an axial direction thereof oriented in a width direction of the vehicle body, and is supported inside the gear housing 11 so as to be capable of linear motion in the axial direction. Base end portions of a pair of tie rods 13 are coupled to end portions of the linear motion member on both sides in the axial direction via spherical joints (not shown), and a pair of steered wheels 5 are supported at tip end portions of the pair of tie rods 13.

When the linear motion member is implemented by a rack shaft, the steering actuator 12 includes a pinion shaft that meshes with the rack shaft, a steering motor, and a reducer. The output torque of the steering motor is increased by the reducer and then input to the pinion shaft, which is rotated to cause the rack shaft to move linearly.

When the linear motion member is implemented by a screw shaft, the steering actuator 12 includes a nut supported around the screw shaft so as to be rotatable with respect to the screw shaft, a steering motor, and a reducer. The steering actuator 12 increases the output torque of the steering motor by the reducer and then inputs it to the nut, and the nut is rotated and driven to linearly move the screw shaft. It should be noted that a feed screw mechanism including a screw shaft and a nut may be configured as a sliding screw type feed screw mechanism in which a male screw portion provided on an outer peripheral surface of the screw shaft and a female screw portion provided on an inner peripheral surface of the nut are directly screwed together, or may also be configured as a ball screw type feed screw mechanism in which a plurality of balls are arranged to roll freely between an inner diameter side ball screw groove provided in an outer peripheral surface of the screw shaft and an outer diameter side ball screw groove provided in an inner peripheral surface of the nut.

In the steering device 1 according to this example, when the driver operates the steering wheel 2, the operation of the steering wheel 2 is measured by a sensor of the steering unit 3, and a measurement result is output to the control unit 7. The control unit 7 receives various signals indicating driving conditions such as steering torque measured by a torque sensor, a steering angle measured by a steering angle sensor, a vehicle speed, a yaw rate, and acceleration. The control unit 7 drives the steering actuator 12 provided in the steered unit 6 based on various signals indicating the driving conditions. As a result, the linear motion member is displaced in the width direction of the vehicle body, and the pair of tie rods 13 are pushed and pulled, thereby applying a steering angle to the pair of steered wheels 5.

### <Structure of Rotation Limiting Device 4>

The rotation limiting device 4 of the present example is provided between the front portion of the steering shaft 9 and the steering column 8 that does not rotate even during use. By limiting a rotatable amount of the steering shaft 9 to a predetermined value, the number of lock-to-lock turns of the steering wheel 2 is limited. The rotation limiting device 4 includes a first member 14, a second member 15, and one intermediate member 16.

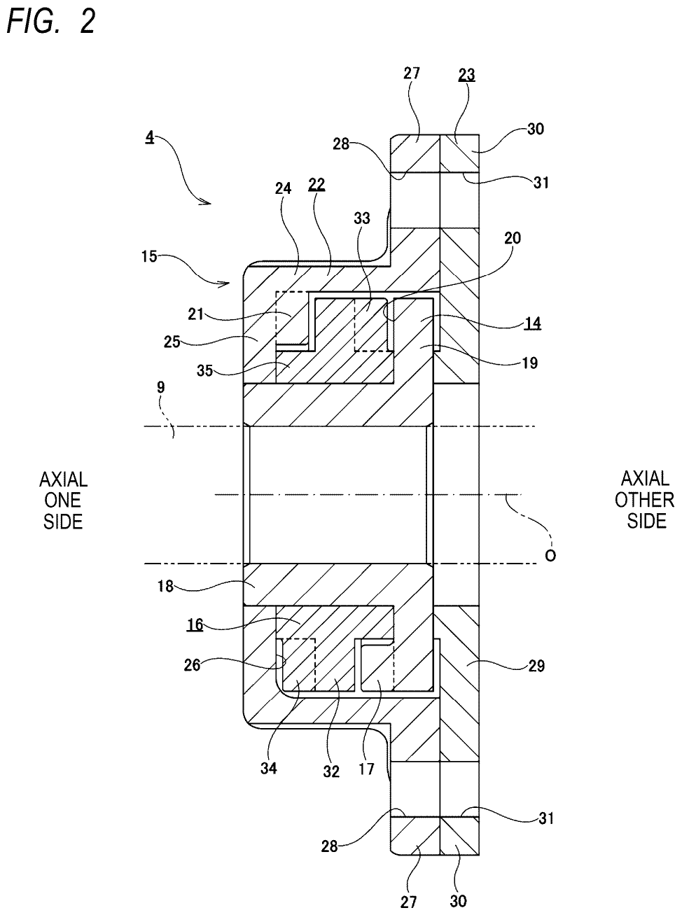

In the first to sixth examples of the embodiment, an axial one side refers to a front side of the vehicle, that is, the left side in FIGS. 2 to 15, and an axial other side refers to a rear side of the vehicle, that is, the right side in FIGS. 2 to 15.

The first member 14 has a first protrusion 17.

In this example, the first member 14 includes a first cylindrical portion 18 having a cylindrical shape and a first flange portion 19 having a hollow circular plate shape protruding toward a radially outer side from an outer peripheral surface of an end portion of the first cylindrical portion 18 on the axial other side.

The first cylindrical portion 18 is externally fitted and fixed to the front portion of the steering shaft 9 so as not to be rotatable relative to the front portion. That is, the first member 14 rotates together with the steering shaft 9.

The first flange portion 19 has a first side surface 20 on an axial one side surface, and has the first protrusion 17 protruding toward the axial one side at one position in the circumferential direction of a radially outer side portion of the first side surface 20. A radially inner side surface of the first protrusion 17 faces the outer peripheral surface of the end portion of the first cylindrical portion 18 on the axial other side with a gap therebetween.

In this example, the first protrusion 17 has a sector-shaped end surface when viewed from the axial one side. That is, the radially inner side surface and a radially outer side surface of the first protrusion 17 have a circular arc-shaped contour centered on a central axis O of the first member 14 when viewed from the axial one side. The radially outer side surface of the first protrusion 17 is in a cylindrical surface the same as an outer peripheral surface of the first flange portion 19. That is, the first protrusion 17 does not protrude toward a radially outer side from the first flange portion 19. Side surfaces of the first protrusion 17 on both sides in the circumferential direction have a linear contour shape extending in a radiation direction about the central axis O of the first member 14 when viewed from the axial one side, and extend linearly in the axial direction when viewed from the radially outer side. That is, the side surfaces of the first protrusion 17 on both sides in the circumferential direction exist within an imaginary plane including the central axis O of the first member 14. In this example, a circumferential width of the first protrusion 17, that is, an angle formed by the side surfaces on both sides in the circumferential direction, is set to 45 degrees.

The second member 15 has a second protrusion 21 disposed on the axial one side with respect to the first protrusion 17, and is disposed coaxially with the first member 14 and capable of relative rotation with respect to the first member 14.

In this example, the second member 15 includes a housing body 22 and a lid body 23.

The housing body 22 includes a second cylindrical portion 24 having a cylindrical shape, and a second flange portion 25 having a hollow circular plate shape bent toward the radially inner side from an end portion of the second cylindrical portion 24 on the axial one side.

The second flange portion 25 has a second side surface 26 on the axial other side surface, and has the second protrusion 21 at one position in the circumferential direction of a radially outer side portion of the second side surface 26. An end portion of the second protrusion 21 on the radially outer side is connected to an end portion on the axial one side of an inner peripheral surface of the second cylindrical portion 24.

In this example, the second protrusion 21 has a sector-shaped end surface when viewed from the axial other side. That is, a radially inner side surface and a radially outer side surface of the second protrusion 21 have a circular arc-shaped contour centered on the central axis O of the second member 15 when viewed from the axial other side. Side surfaces of the second protrusion 21 on both sides in the circumferential direction have a linear contour shape extending in a radiation direction about the central axis O of the second member 15 when viewed from the axial other side, and extend linearly in the axial direction when viewed from the radially inner side. That is, the side surfaces of the second protrusion 21 on both sides in the circumferential direction exist within an imaginary plane including the central axis O of the second member 15. In this example, a circumferential width of the second protrusion 21 is set to 45 degrees.

The housing body 22 further includes a pair of body side ear portions 27 protruding to the radially outer side from two radially opposite positions on an end portion of the second cylindrical portion 24 on the axial other side. Each of the body side ear portions 27 has a body side coupling hole 28 passing therethrough in the axial direction. In this example, the body side coupling hole 28 is formed as a cylindrical hole whose inside diameter does not change in the axial direction.

In this example, the housing body 22, including the second protrusion 21, is constructed as a whole. However, when implementing the present disclosure, the second protrusion may be provided by supporting and fixing a separately constructed pin on the second side surface of the second flange portion.

The lid body 23 covers (blocks) a radially outer side portion of an opening portion on the axial other side of the second cylindrical portion 24 of the housing body 22. In this example, the lid body 23 has a blocking plate portion 29 in a hollow circular plate shape, and a pair of lid side ear portions 30 protruding to the radially outer side from two radially opposite positions of the blocking plate portion 29. Each of the lid side ear portions 30 has a lid side coupling hole 31 passing therethrough in the axial direction. In this example, the lid side coupling hole 31 is formed as a screw hole.

In this example, the pair of lid side ear portions 30 are overlapped with the pair of body side ear portions 27 on the axial other side, coupling bolts (not shown) are inserted into the pair of body side coupling holes 28, and the coupling bolts are screwed into the pair of lid side coupling holes 31, thereby coupling and fixing the housing body 22 and the lid body 23. The rotation limiting device 4 of the present example is supported and fixed to the steering column 8 that does not rotate even during use by screwing the coupling bolts into the column side screw holes that open in a front side surface of the steering column 8.

The intermediate member 16 includes a side plate portion 32 disposed between the first protrusion 17 and the second protrusion 21 in the axial direction, an intermediate side first protrusion 33 protruding from an axial other side surface of the side plate portion 32 toward the axial other side, and an intermediate side second protrusion 34 protruding from an axial one side surface of the side plate portion 32 toward the axial one side. The intermediate member 16 is supported coaxially with the first member 14 and the second member 15, and is relatively rotatable with respect to the first member 14 and the second member 15.

In this example, the intermediate member 16 includes a cylindrical intermediate cylindrical portion 35 that is externally fitted to the first cylindrical portion 18 of the first member 14 so as to be rotatable relative to the first cylindrical portion 18, and the side plate portion 32 in a hollow circular plate shape that protrudes toward the radially outer side from an outer peripheral surface of an intermediate portion of the intermediate cylindrical portion 35 in the axial direction.

Further, the intermediate member 16 has the intermediate side first protrusion 33 protruding toward the axial other side from the axial other side surface of the side plate portion 32 at one position in the circumferential direction, and the intermediate side second protrusion 34 protruding toward the axial one side from the axial one side surface of the side plate portion 32 at one position radially opposite to the intermediate side first protrusion 33 (one position whose phase in the circumferential direction is shifted by 180 degrees from the intermediate side first protrusion 33). An end portion of the intermediate side first protrusion 33 on the radially inner side is connected to an axial other side portion of an outer peripheral surface of the intermediate cylindrical portion 35, and an end portion of the radially inner side of the intermediate side second protrusion 34 is connected to an axial one side portion of an outer peripheral surface of the intermediate cylindrical portion 35.

In this example, the intermediate side first protrusion 33 has a sector-shaped end surface when viewed from the axial other side. That is, a radially inner side surface and a radially outer side surface of the intermediate side first protrusion 33 have a circular arc-shaped contour centered on a central axis O of the intermediate member 16 when viewed from the axial other side. A radially outer side surface of the intermediate side first protrusion 33 is in a cylindrical surface the same as an outer peripheral surface of the side plate portion 32. That is, the intermediate side first protrusion 33 is formed integrally with the side plate portion 32 and does not protrude toward the radially outer side from the side plate portion 32. That is, the intermediate side first protrusion 33 is located on the radially inner side of the outer peripheral surface of the side plate portion 32. The radially outer side surface of the intermediate side first protrusion 33 may not necessarily be in the same cylindrical surface as the outer peripheral surface of the side plate portion 32 as long as the radially outer side surface of the intermediate side first protrusion 33 is located on the radially inner side of the outer peripheral surface of the side plate portion 32. Side surfaces of the intermediate side first protrusion 33 on both sides in the circumferential direction have a linear contour shape extending in a radiation direction about the central axis O of the intermediate member 16 when viewed from the axial other side, and extend linearly in the axial direction when viewed from the radially outer side. That is, the side surfaces of the intermediate side first protrusion 33 on both sides in the circumferential direction exist within an imaginary plane including the central axis O of the intermediate member 16. In this example, a circumferential width of the intermediate side first protrusion 33 is set to 45 degrees.

In this example, the intermediate side second protrusion 34 has a sector-shaped end surface when viewed from the axial one side. That is, a radially inner side surface and a radially outer side surface of the intermediate side second protrusion 34 have a circular arc-shaped contour centered on a central axis O of the intermediate member 16 when viewed from the axial one side. A radially outer side surface of the intermediate side second protrusion 34 is in a cylindrical surface the same as the outer peripheral surface of the side plate portion 32. That is, the intermediate side second protrusion 34 is formed integrally with the side plate portion 32 and does not protrude toward the radially outer side from the side plate portion 32. That is, the intermediate side second protrusion 34 is located on the radially inner side of the outer peripheral surface of the side plate portion 32. The radially outer side surface of the intermediate side second protrusion 34 may not necessarily be in the same cylindrical surface as the outer peripheral surface of the side plate portion 32 as long as the radially outer side surface of the intermediate side second protrusion 34 is located on the radially inner side of the outer peripheral surface of the side plate portion 32. Side surfaces of the intermediate side second protrusion 34 on both sides in the circumferential direction have a linear contour shape extending in a radiation direction about the central axis O of the intermediate member 16 when viewed from the axial one side, and extend linearly in the axial direction when viewed from the radially outer side. That is, the side surfaces of the intermediate side second protrusion 34 on both sides in the circumferential direction exist within the imaginary plane including the central axis O of the intermediate member 16. In this example, a circumferential width of the intermediate side second protrusion 34 is set to 45 degrees.

The rotation limiting device 4 according to this example is formed by combining the first member 14 and the intermediate member 16 inside the second member 15 so as to be rotatable relative to each other. Specifically, the intermediate cylindrical portion 35 of the intermediate member 16 is externally fitted to an axial other side portion of the first cylindrical portion 18 of the first member 14 in a relatively rotatable manner without rattling, and an end portion of the first cylindrical portion 18 on the axial one side is internally fitted to the second flange portion 25 of the housing body 22 in a relatively rotatable manner without rattling. Further, a radially inner side portion of the axial other side surface of the second flange portion 25 is brought into sliding contact with or closely opposed to an end surface of the intermediate cylindrical portion 35 on the axial one side, and a radially inner side portion on the axial one side surface of the blocking plate portion 29 of the lid body 23 is brought into sliding contact with or closely opposed to the axial other side surface of the first flange portion 19 of the first member 14. In a state where the rotation limiting device 4 is assembled in this manner, an axial one side surface of the first protrusion 17 faces the axial other side surface of the side plate portion 32 with a gap therebetween, and an axial other side surface of the second protrusion 21 faces the axial one side surface of the side plate portion 32 with a gap therebetween. Further, an axial other side surface of the intermediate side first protrusion 33 faces an axial one side surface of the first flange portion 19 with a gap therebetween, and an axial one side surface of the intermediate side second protrusion 34 faces an axial other side surface of the second flange portion 25 with a gap therebetween.

### <Operation of Rotation Limiting Device 4>

The operation of the rotation limiting device 4 according to this example will be described with reference to (A) of FIG. 4 to (C) of FIG. 5. (A) of FIG. 4 to (C) of FIG. 5 are views schematically illustrating the first protrusion 17 of the first member 14, the second protrusion 21 of the second member 15, and the intermediate member 16 as viewed from the radially outer side. In the following description, a circumferential one side refers to a front side in a counterclockwise direction as seen from a driver seated in a driver seat, that is, the lower side in (A) of FIG. 4 to (C) of FIG. 5, and a circumferential other side refers to a front side in a clockwise direction as seen from the driver seated in the driver seat, that is, the upper side in (A) of FIG. 4 to (C) of FIG. 5.

First, when the steering wheel 2 is operated from fully left (the counterclockwise direction as seen from the driver seated in the driver seat) to fully right (the clockwise direction as seen from the driver seated in the driver seat), the rotation limiting device 4 operates as shown in the order of (A) of FIG. 4→(B) of FIG. 4→(C) of FIG. 4.

That is, in a state in which the steering wheel 2 is operated to fully left, as shown in (A) of FIG. 4, a circumferential one side surface of the first protrusion 17 is in contact with a circumferential other side surface of the intermediate side first protrusion 33, and a circumferential other side surface of the second protrusion 21 is in contact with a circumferential one side surface of the intermediate side second protrusion 34.

From this state, when the steering wheel 2 is operated to the right and the steering shaft 9 is rotated in the clockwise direction, as shown by an arrow in (A) of FIG. 4, only the first member 14 rotates in the clockwise direction (toward the circumferential other side) while the circumferential other side surface of the second protrusion 21 remains in contact with the circumferential one side surface of the intermediate side second protrusion 34. Then, when the first member 14 is rotated by an angle smaller than 360 degrees by the sum of the circumferential width of the first protrusion 17 and the circumferential width of the intermediate side first protrusion 33, that is, 270 degrees in this example, as shown in (B) of FIG. 4, a circumferential other side surface of the first protrusion 17 comes into contact with a circumferential one side surface of the intermediate side first protrusion 33. In this state, the steering wheel 2 is located at the center, and the pair of steered wheels 5 are oriented in a straight ahead direction.

When the steering wheel 2 is further operated to the right from the state shown in (B) of FIG. 4, as indicated by an arrow in (B) of FIG. 4, the circumferential one side surface of the intermediate side first protrusion 33 is pressed toward the circumferential other side by the circumferential other side surface of the first protrusion 17. As a result, the first member 14 and the intermediate member 16 rotate together in the clockwise direction (toward the circumferential other side). Then, when the first member 14 and the intermediate member 16 are rotated in the clockwise direction by an angle smaller than 360 degrees by the sum of the circumferential width of the second protrusion 21 and the circumferential width of the intermediate side second protrusion 34, that is, 270 degrees in this example, as shown in (C) of FIG. 4, a circumferential other side surface of the intermediate side second protrusion 34 comes into contact with a circumferential one side surface of the second protrusion 21. When the circumferential other side surface of the intermediate side second protrusion 34 comes into contact with the circumferential one side surface of the second protrusion 21, the intermediate member 16 is prevented from rotating further in the clockwise direction with respect to the second member 15. When the intermediate member 16 is prevented from rotating in the clockwise direction, the first member 14 is prevented from rotating further in the clockwise direction.

Alternatively, when the first member 14 rotates in the clockwise direction by operating the steering wheel 2 to the right from the state shown in (A) of FIG. 4, the intermediate member 16 is rotated together with the first member 14 due to a friction force acting between an outer peripheral surface of the first cylindrical portion 18 and an inner peripheral surface of the intermediate cylindrical portion 35, and the first member 14 and the intermediate member 16 rotate together. Then, the circumferential other side surface of the intermediate side second protrusion 34 comes into contact with the circumferential one side surface of the second protrusion 21, and the intermediate member 16 is prevented from rotating further in the clockwise direction with respect to the second member 15. From this state, when the steering wheel 2 is further operated to the right, only the first member 14 rotates in the clockwise direction. Then, the circumferential other side surface of the first protrusion 17 comes into contact with the circumferential one side surface of the intermediate side first protrusion 33, and the first member 14 is prevented from rotating further in the clockwise direction with respect to the intermediate member 16.

In either case, when the first member 14 is prevented from rotating further in the clockwise direction, the steering shaft 9 and the steering wheel 2 supported and fixed to the steering shaft 9 are prevented from rotating further in the clockwise direction.

Next, when the steering wheel 2 is operated from fully right to fully left, the rotation limiting device 4 operates as shown in the order of (A) of FIG. 5→(B) of FIG. 5→(C) of FIG. 5.

That is, in a state in which the steering wheel 2 is operated to fully right, as shown in (A) of FIG. 5, the circumferential other side surface of the first protrusion 17 is in contact with the circumferential one side surface of the intermediate side first protrusion 33, and the circumferential one side surface of the second protrusion 21 is in contact with the circumferential other side surface of the intermediate side second protrusion 34.

From this state, when the steering wheel 2 is operated to the left and the steering shaft 9 is rotated in the counterclockwise direction, as shown by an arrow in (A) of FIG. 5, only the first member 14 rotates in the counterclockwise direction (toward the circumferential one side) while the circumferential one side surface of the second protrusion 21 remains in contact with the circumferential other side surface of the intermediate side second protrusion 34. Then, when the first member 14 is rotated by an angle smaller than 360 degrees by the sum of the circumferential width of the first protrusion 17 and the circumferential width of the intermediate side first protrusion 33, that is, 270 degrees in this example, as shown in (B) of FIG. 5, the circumferential one side surface of the first protrusion 17 comes into contact with the circumferential other side surface of the intermediate side first protrusion 33. In this state, the steering wheel 2 is located at the center, and the pair of steered wheels 5 are oriented in a straight ahead direction.

When the steering wheel 2 is further operated to the left from the state shown in (B) of FIG. 5, as indicated by an arrow in (B) of FIG. 5, the circumferential other side surface of the intermediate side first protrusion 33 is pressed toward the circumferential one side by the circumferential one side surface of the first protrusion 17. As a result, the first member 14 and the intermediate member 16 rotate together in the counterclockwise direction (toward the circumferential one side). Then, when the first member 14 and the intermediate member 16 are rotated in the counterclockwise direction by an angle smaller than 360 degrees by the sum of the circumferential width of the second protrusion 21 and the circumferential width of the intermediate side second protrusion 34, that is, 270 degrees in this example, as shown in (C) of FIG. 5, the circumferential one side surface of the intermediate side second protrusion 34 comes into contact with the circumferential other side surface of the second protrusion 21. When the circumferential one side surface of the intermediate side second protrusion 34 comes into contact with the circumferential other side surface of the second protrusion 21, the intermediate member 16 is prevented from rotating further in the counterclockwise direction with respect to the second member 15. When the intermediate member 16 is prevented from rotating in the counterclockwise direction, the first member 14 is prevented from rotating further in the counterclockwise direction.

Alternatively, when the first member 14 rotates in the counterclockwise direction by operating the steering wheel 2 to the left from the state shown in (A) of FIG. 5, the intermediate member 16 is rotated together with the first member 14 due to a friction force acting between an outer peripheral surface of the first cylindrical portion 18 and an inner peripheral surface of the intermediate cylindrical portion 35, and the first member 14 and the intermediate member 16 rotate together. Then, the circumferential one side surface of the intermediate side second protrusion 34 comes into contact with the circumferential other side surface of the second protrusion 21, and the intermediate member 16 is prevented from rotating further in the counterclockwise direction with respect to the second member 15. From this state, when the steering wheel 2 is further operated to the left, only the first member 14 rotates in the counterclockwise direction. Then, the circumferential one side surface of the first protrusion 17 comes into contact with the circumferential other side surface of the intermediate side first protrusion 33, and the first member 14 is prevented from rotating further in the counterclockwise direction with respect to the intermediate member 16.

In either case, when the first member 14 is prevented from rotating further in the counterclockwise direction, the steering shaft 9 and the steering wheel 2 supported and fixed to the steering shaft 9 are prevented from rotating further in the counterclockwise direction.

The rotation limiting device 4 according to the present example can adjust the rotatable amount of the steering shaft 9 coupled and fixed to the first member 14 by changing the number of intermediate members 16 disposed between the first protrusion 17 and the second protrusion 21 in the axial direction. Therefore, according to the rotation limiting device 4 of the present example, it is possible to improve the degree of freedom in setting the rotatable amount of the steering shaft 9. Specifically, as the number of the intermediate members 16 is increased, the rotatable amount of the steering shaft 9 can be increased.

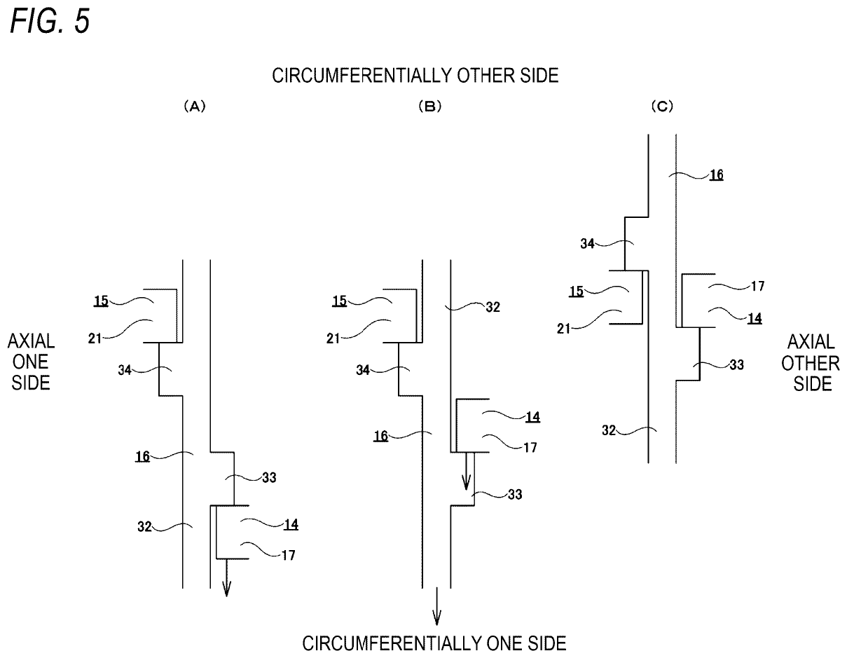

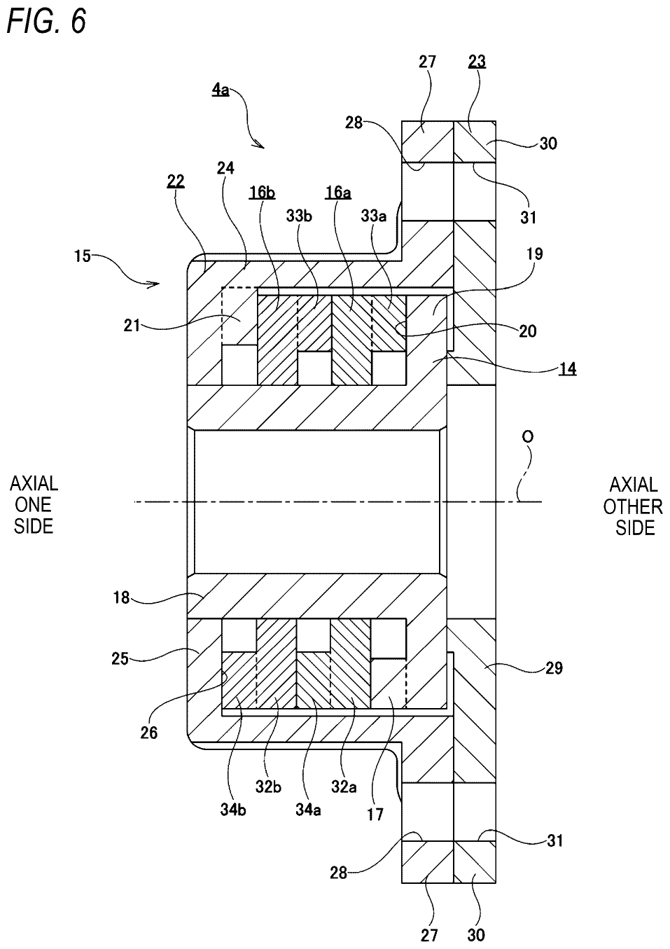

FIG. 6 to (D) of FIG. 8 show a rotation limiting device 4a including two intermediate members 16a and 16b. The intermediate members 16a and 16b respectively include: side plate portions 32a and 32b having a hollow circular plate shape; intermediate side first protrusions 33a and 33b protruding toward the axial other side from respective axial other side surfaces of the side plate portions 32a and 32b at one position in the circumferential direction; and intermediate side second protrusions 34a and 34b protruding toward the axial one side from respective axial one side surfaces at one position radially opposite to the intermediate side first protrusions 33a and 33b. That is, the intermediate members 16a and 16b do not include the intermediate cylindrical portion 35 that is provided in the intermediate member 16 according to the first example of the embodiment. The two intermediate members 16a and 16b are arranged in series in the axial direction and are externally fitted to the first cylindrical portion 18 of the first member 14 so as to be rotatable relative to each other. The intermediate member 16a on the axial other side and the intermediate member 16b on the axial one side are given different reference numerals for the sake of convenience of explanation, but have the same shape. An axial length of the first cylindrical portion 18 and an axial length of the second cylindrical portion 24 are longer than that of the structure according to the first example of the embodiment by an amount of the intermediate members 16a and 16b added.

In the steering unit 3 (see FIG. 1) including the rotation limiting device 4a according to the present modification, when the steering wheel 2 is operated from fully left to fully right, the rotation limiting device 4a operates as shown in the order of (A) of FIG. 7→(B) of FIG. 7→(C) of FIG. 7→(D) of FIG. 7.

In a state in which the steering wheel 2 is operated to fully left, as shown in (A) of FIG. 7, the circumferential one side surface of the first protrusion 17 is in contact with a circumferential other side surface of the intermediate side first protrusion 33a of the intermediate member 16a on the axial other side, a circumferential one side surface of the intermediate side second protrusion 34a of the intermediate member 16a on the axial other side is in contact with a circumferential other side surface of the intermediate side first protrusion 33b of the intermediate member 16b on the axial one side, and a circumferential one side surface of the intermediate side second protrusion 34b of the intermediate member 16b on the axial one side is in contact with the circumferential other side surface of the second protrusion 21.

From this state, when the steering wheel 2 is operated to the right and the steering shaft 9 is rotated in the clockwise direction, as shown by an arrow in (A) of FIG. 7, only the first member 14 rotates in the clockwise direction (toward the circumferential other side) while the circumferential one side surface of the intermediate side second protrusion 34a of the intermediate member 16a on the axial other side remains in contact with the circumferential other side surface of the intermediate side first protrusion 33b of the intermediate member 16b on the axial one side, and the circumferential one side surface of the intermediate side second protrusion 34b of the intermediate member 16b on the axial one side remains in contact with the circumferential other side surface of the second protrusion 21. When the first member 14 rotates in the clockwise direction by an angle smaller than 360 degrees by the sum of the circumferential width of the first protrusion 17 and a circumferential width of the intermediate side first protrusion 33a, as shown in (B) of FIG. 7, the circumferential other side surface of the first protrusion 17 comes into contact with a circumferential one side surface of the intermediate side first protrusion 33a of the intermediate member 16a on the axial other side.

When the steering wheel 2 is further operated to the right from the state shown in (B) of FIG. 7, as indicated by an arrow in (B) of FIG. 7, the circumferential one side surface of the intermediate side first protrusion 33a of the intermediate member 16a on the axial other side is pressed toward the circumferential other side by the circumferential other side surface of the first protrusion 17. As a result, with the circumferential one side surface of the intermediate side second protrusion 34b of the intermediate member 16b on the axial one side remaining in contact with the circumferential other side surface of the second protrusion 21, the first member 14 and the intermediate member 16a on the axial other side rotate in the clockwise direction (toward the circumferential other side) integrally. Then, when the first member 14 and the intermediate member 16a on the axial other side rotate in the clockwise direction by an angle that is smaller than 360 degrees by the sum of a circumferential width of the intermediate side second protrusion 34a of the intermediate member 16a on the axial other side and a circumferential width of the intermediate side first protrusion 33b of the intermediate member 16b on the axial one side, as illustrated in (C) of FIG. 7, a circumferential other side surface of the intermediate side second protrusion 34a of the intermediate member 16a on the axial other side comes into contact with a circumferential one side surface of the intermediate side first protrusion 33b of the intermediate member 16b on the axial one side.

When the first member 14 and the intermediate member 16a on the axial other side integrally rotate in the clockwise direction by operating the steering wheel 2 further to the right from the state shown in (C) of FIG. 7, as shown by an arrow in (C) of FIG. 7, the circumferential one side surface of the intermediate side first protrusion 33b of the intermediate member 16b on the axial one side is pressed toward the circumferential other side by the circumferential other side surface of the intermediate side second protrusion 34a of the intermediate member 16a on the axial other side. As a result, the first member 14 and the two intermediate members 16a and 16b rotate together in the clockwise direction (toward the circumferential other side). Then, when the first member 14 and the two intermediate members 16a and 16b rotate in the clockwise direction by an angle that is smaller than 360 degrees by the sum of a circumferential width of the intermediate side second protrusion 34b of the intermediate member 16b on the axial one side and the circumferential width of the second protrusion 21, as shown in (D) of FIG. 7, a circumferential other side surface of the intermediate side second protrusion 34b of the intermediate member 16b on the axial one side comes into contact with the circumferential one side surface of the second protrusion 21. As a result, the intermediate member 16b on the axial one side is prevented from rotating further in the clockwise direction with respect to the second member 15. When the intermediate member 16b on the axial one side is prevented from rotating in the clockwise direction, the intermediate member 16a on the axial other side is prevented from rotating further in the clockwise direction. When the intermediate member 16a on the axial other side is prevented from rotating in the clockwise direction, the first member 14 is prevented from rotating further in the clockwise direction, and the steering shaft 9 and the steering wheel 2 supported and fixed to the steering shaft 9 are prevented from rotating further in the clockwise direction.

On the other hand, when the steering wheel 2 is operated from fully right to fully left, the rotation limiting device 4a operates as shown in the order of (A) of FIG. 8, (B) of FIG. 8, (C) of FIG. 8, and (D) of FIG. 8.

That is, in a state in which the steering wheel 2 is operated to fully right, as shown in (A) of FIG. 8, the circumferential other side surface of the first protrusion 17 is in contact with a circumferential one side surface of the intermediate side first protrusion 33a of the intermediate member 16a on the axial other side, a circumferential other side surface of the intermediate side second protrusion 34a of the intermediate member 16a on the axial other side is in contact with a circumferential one side surface of the intermediate side first protrusion 33b of the intermediate member 16b on the axial one side, and a circumferential other side surface of the intermediate side second protrusion 34b of the intermediate member 16b on the axial one side is in contact with the circumferential one side surface of the second protrusion 21.

From this state, when the steering wheel 2 is operated to the left and the steering shaft 9 is rotated in the counterclockwise direction, as shown by an arrow in (A) of FIG. 8, only the first member 14 rotates in the counterclockwise direction (toward the circumferential one side) while the circumferential other side surface of the intermediate side second protrusion 34a of the intermediate member 16a on the axial other side remains in contact with the circumferential one side surface of the intermediate side first protrusion 33b of the intermediate member 16b on the axial one side, and the circumferential other side surface of the intermediate side second protrusion 34b of the intermediate member 16b on the axial one side remains in contact with the circumferential one side surface of the second protrusion 21. When the first member 14 rotates in the counterclockwise direction by an angle smaller than 360 degrees by the sum of the circumferential width of the first protrusion 17 and a circumferential width of the intermediate side first protrusion 33a, as shown in (B) of FIG. 8, the circumferential one side surface of the first protrusion 17 comes into contact with a circumferential other side surface of the intermediate side first protrusion 33a of the intermediate member 16a on the axial other side.

When the steering wheel 2 is further operated to the left from the state shown in (B) of FIG. 8, as indicated by an arrow in (B) of FIG. 8, the circumferential other side surface of the intermediate side first protrusion 33a of the intermediate member 16a on the axial other side is pressed toward the circumferential one side by the circumferential one side surface of the first protrusion 17. As a result, with the circumferential other side surface of the intermediate side second protrusion 34b of the intermediate member 16b on the axial one side remaining in contact with the circumferential one side surface of the second protrusion 21, the first member 14 and the intermediate member 16a on the axial other side rotate in the counterclockwise direction (toward the circumferential one side) integrally. Then, when the first member 14 and the intermediate member 16a on the axial other side rotate in the counterclockwise direction by an angle that is smaller than 360 degrees by the sum of a circumferential width of the intermediate side second protrusion 34a of the intermediate member 16a on the axial other side and a circumferential width of the intermediate side first protrusion 33b of the intermediate member 16b on the axial one side, as illustrated in (C) of FIG. 8, a circumferential one side surface of the intermediate side second protrusion 34a of the intermediate member 16a on the axial other side comes into contact with a circumferential other side surface of the intermediate side first protrusion 33b of the intermediate member 16b on the axial one side.

When the first member 14 and the intermediate member 16a on the axial other side integrally rotate in the counterclockwise direction by operating the steering wheel 2 further to the left from the state shown in (C) of FIG. 8, as shown by an arrow in (C) of FIG. 8, the circumferential other side surface of the intermediate side first protrusion 33b of the intermediate member 16b on the axial one side is pressed toward the circumferential one side by the circumferential one side surface of the intermediate side second protrusion 34a of the intermediate member 16a on the axial other side. As a result, the first member 14 and the two intermediate members 16a and 16b rotate together in the counterclockwise direction (toward the circumferential one side). Then, when the first member 14 and the two intermediate members 16a and 16b rotate in the counterclockwise direction by an angle that is smaller than 360 degrees by the sum of a circumferential width of the intermediate side second protrusion 34b of the intermediate member 16b on the axial one side and the circumferential width of the second protrusion 21, as shown in (D) of FIG. 8, a circumferential one side surface of the intermediate side second protrusion 34b of the intermediate member 16b on the axial one side comes into contact with the circumferential other side surface of the second protrusion 21. As a result, the intermediate member 16b on the axial one side is prevented from rotating further in the counterclockwise direction with respect to the second member 15. When the intermediate member 16b on the axial one side is prevented from rotating in the counterclockwise direction, the intermediate member 16a on the axial other side is prevented from rotating further in the counterclockwise direction. When the intermediate member 16a on the axial other side is prevented from rotating in the counterclockwise direction, the first member 14 is prevented from rotating further in the counterclockwise direction, and the steering shaft 9 and the steering wheel 2 supported and fixed to the steering shaft 9 are prevented from rotating further in the counterclockwise direction.

In this modification, the intermediate member 16a on the axial one side and/or the intermediate member 16b on the axial other side may also be rotated together with the first member 14 due to a friction force acting between the outer peripheral surface of the first cylindrical portion 18 of the first member 14 and an inner peripheral surface of the side plate portion 32a of the intermediate member 16a on the axial other side and/or an inner peripheral surface of the side plate portion 32b of the intermediate member 16b on the axial one side. In this case, an operation order of the rotation limiting device 4a may be different from the example shown in FIGS. 7 and 8.

In either case, as described above, the rotation limiting device 4 (4a) according to the present example can increase the rotatable amount of the steering shaft 9 by increasing the number of the intermediate members 16 (16a, 16b) having the intermediate side first protrusions 33 (33a, 33b) protruding toward the axial other side and the intermediate side second protrusions 34 (34a, 34b) protruding toward the axial one side, and arranging the intermediate members 16 (16a, 16b) in series in the axial direction. Specifically, when the circumferential width W of the first protrusion 17, the second protrusion 21, the intermediate side first protrusion 33 (33a, 33b), and the intermediate side second protrusion 34 (34a, 34b) are all the same, each time one intermediate member 16 is added, the rotatable amount of the steering shaft 9 can be increased by an angle that is smaller than 360 degrees by twice the circumferential width W (2W).

In the case where the circumferential width W is 45 degrees, each time one intermediate member 16 (16a, 16b) is added, the rotatable amount of the steering shaft 9 can be increased by 270 degrees, and the number of lock-to-lock turns of the steering wheel 2 can be increased by 0.75. For example, as in the first example of the embodiment, in the rotation limiting device 4 including only one intermediate member 16, the rotatable amount of the steering shaft 9 is 540 degrees (the number of lock-to-lock turns of the steering wheel 2 is 1.5), while in the modification, in the rotation limiting device 4a having the two intermediate members 16a and 16b, the rotatable amount of the steering shaft 9 can be set to 810 degrees (the number of lock-to-lock turns of the steering wheel 2 is 2.25).

In the rotation limiting device 4a according to the present modification, the two intermediate members 16a and 16b have the same shape. That is, in the rotation limiting device according to the present disclosure, the rotatable amount of the rotation member can be adjusted by increasing or decreasing the number of intermediate members having the same shape. Therefore, according to the rotation limiting device of the present disclosure, it is possible to prevent an unnecessary increase in the manufacturing cost and the management cost of the parts and the assembling cost, and to suppress an increase in the manufacturing cost of the rotation limiting device.

In the rotation limiting device 4 according to the present example, the first member 14 and the intermediate member 16 are sandwiched in the axial direction between the housing body 22 and the lid body 23 that constitute the second member 15, and are disposed on the radially inner side of the second cylindrical portion 24, and the housing body 22 and the lid body 23 are coupled to each other by the coupling bolt. Therefore, even in a state before the first member 14 is coupled and fixed to the steering shaft 9 and the second member 15 is supported and fixed to the steering column 8, the rotation limiting device 4 can be assembled in advance. Therefore, the ease of handling of the rotation limiting device 4 can be improved.

In this example, the housing body 22 and the lid body 23 are coupled and fixed by screwing the coupling bolt inserted into the body side coupling hole 28, which is a cylindrical hole, into the lid side coupling hole 31, which is a screw hole. Alternatively, a coupling bolt inserted into the lid side coupling hole, which is a cylindrical hole, can be screwed into the body side coupling hole, which is a screw hole. Alternatively, both the body side coupling hole and the lid side coupling hole may be formed in screw holes.

Alternatively, in a state before the rotation limiting device 4 is supported and fixed to the steering column 8, when the housing body 22 and the lid body 23 are coupled and fixed by another members such as a clip, or when it is not necessary to assemble the rotation limiting device 4 in advance, both the body side coupling hole and the lid side coupling hole can be formed in cylindrical holes.

Further, according to the rotation limiting device 4 of the present example, it is not necessary to increase the coupling strength of the first member 14 with respect to the steering shaft 9 in the axial direction and the coupling strength of the second member 15 with respect to the steering column 8 in the axial direction.

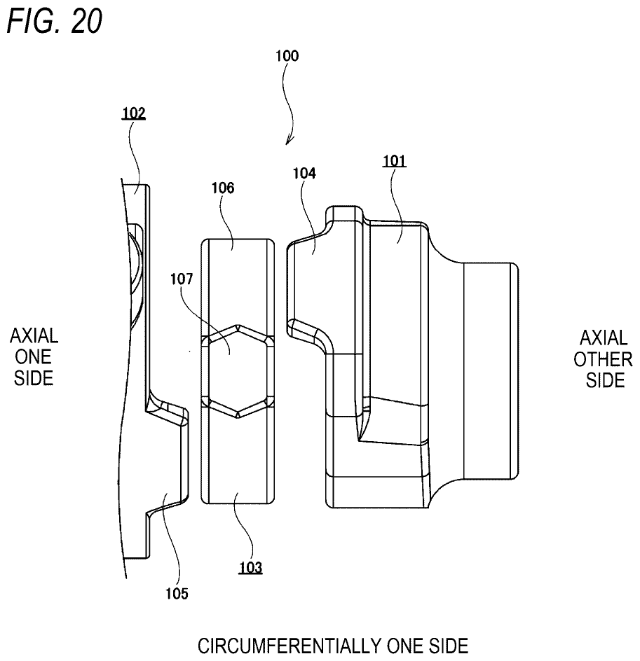

That is, in the stopper unit 100 of a related-art structure shown in FIG. 20, side surfaces of the first rotation protrusion 104 on both sides in the circumferential direction, side surfaces of the fixing protrusion 105 on both sides in the circumferential direction, and side surfaces of the second rotation protrusion 107 on both sides in the circumferential direction are inclined with respect to the axial direction when viewed from the radially outer side. Therefore, when the first rotation member 101 rotates, a force is applied between the first rotation member 101 and the second rotation member 103 and/or between the second rotation member 103 and the housing 102 in a direction in which they are moved away from each other in the axial direction. Accordingly, it is necessary to sufficiently increase the coupling strength of the first rotation member 101 with respect to the steering shaft in the axial direction and the coupling strength of the housing 102 with respect to the vehicle body in the axial direction.

On the other hand, in this example, the side surfaces of the first protrusion 17 on both sides in the circumferential direction, the side surfaces of the second protrusion 21 on both sides in the circumferential direction, the side surfaces of the intermediate side first protrusion 33 on both sides in the circumferential direction, and the side surfaces of the intermediate side second protrusion 34 on both sides in the circumferential direction extend linearly in the axial direction when viewed from the radial direction. Therefore, even when the first member 14 rotates as the steering shaft 9 rotates, no force acts in the axial direction between the first member 14 and the intermediate member 16 and between the intermediate member 16 and the second member 15. Therefore, it is not necessary to increase the coupling strength of the first member 14 with respect to the steering shaft 9 in the axial direction and the coupling strength of the second member 15 with respect to the steering column 8 in the axial direction, and it is possible to prevent the manufacturing cost of the steering device 1 including the rotation limiting device 4 from increasing unnecessarily.

In this example, the circumferential width of the first protrusion 17, the circumferential width of the second protrusion 21, the circumferential width of the intermediate side first protrusion 33, and the circumferential width of the intermediate side second protrusion 34 are all 45 degrees. When implementing the present disclosure, the circumferential width of the first protrusion, the circumferential width of the second protrusion, the circumferential width of the intermediate side first protrusion, and the circumferential width of the intermediate side second protrusion are not particularly limited and may be set freely. However, if the circumferential width is excessively small, the strength of the protrusions cannot be sufficiently ensured. On the other hand, if the circumferential width is excessively large, the rotatable amount of the rotation member becomes excessively small. Taking these into consideration, the circumferential width of the first protrusion, the circumferential width of the second protrusion, the circumferential width of the intermediate side first protrusion, and the circumferential width of the intermediate side second protrusion may be set to 90 degrees or less, and preferably 30 degrees or more and 60 degrees or less.

When the circumferential width of the first protrusion, the circumferential width of the second protrusion, the circumferential width of the intermediate side first protrusion, and the circumferential width of the intermediate side second protrusion are all W [deg], and the number of the intermediate members is n, the rotatable amount α [deg] of the rotation member coupled and fixed to the first member 14 is α=(360−2W)(n+1). Therefore, when W is set to 90 degrees or less, preferably 30 degrees or more and 60 degrees or less, the number of lock-to-lock turns (about 1 to 4.167) of a steering wheel set in a typical automatic vehicle can be achieved with a minimum number of intermediate members (four or less).

Further, in the case of implementing the present disclosure, the circumferential width of the first protrusion, the circumferential width of the second protrusion, the circumferential width of the intermediate side first protrusion, and the circumferential width of the intermediate side second protrusion are not necessarily all the same, and some or all of them may be different.

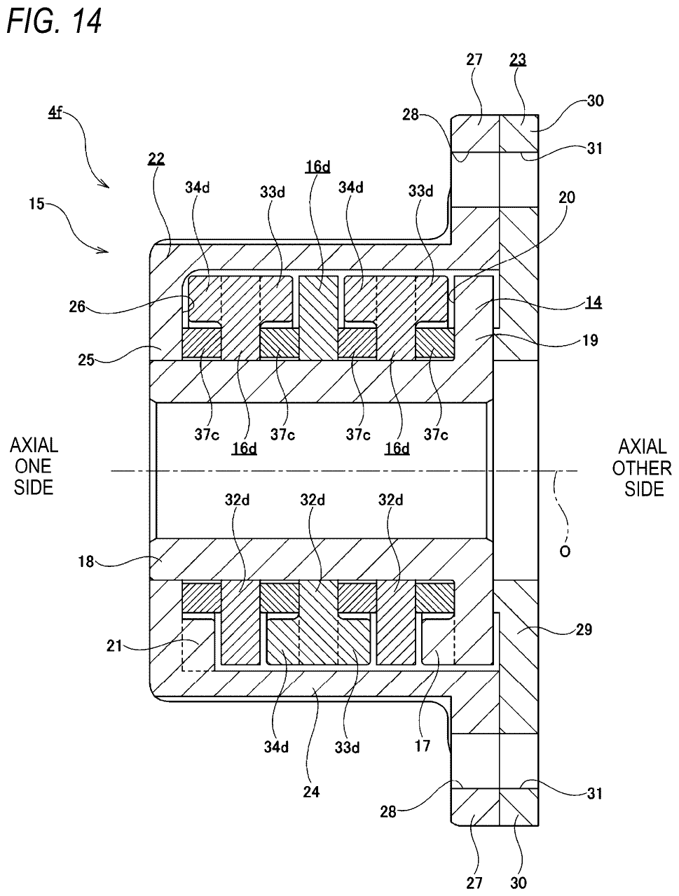

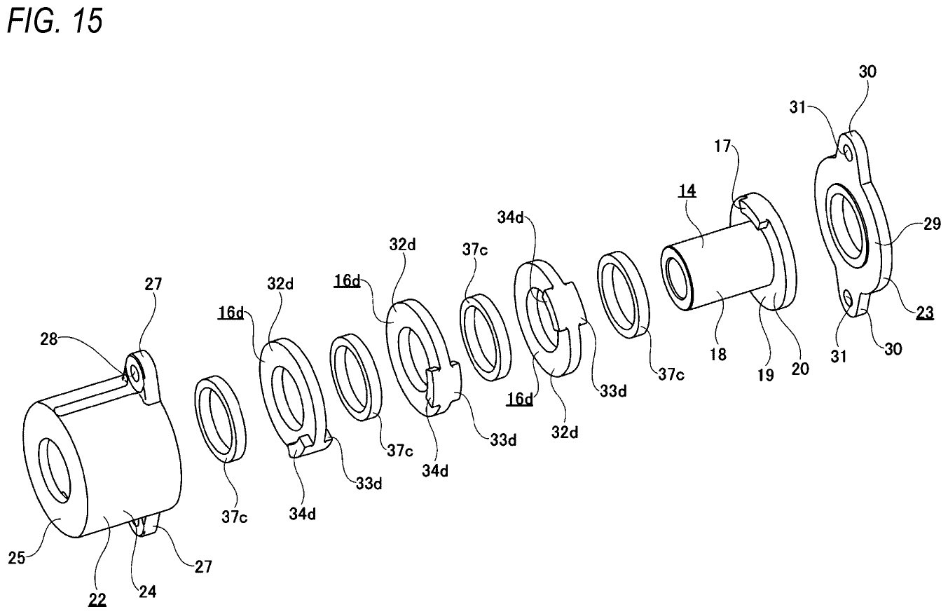

In this example, the intermediate side first protrusion 33 and the intermediate side second protrusion 34 which are provided in the intermediate member 16 are out of phase with each other in the circumferential direction by 180 degrees. Therefore, the center of gravity of the intermediate member 16 can be positioned on the central axis O of the intermediate member 16. Therefore, even when no torque is applied to the steering shaft 9, it is possible to prevent the intermediate member 16 from rotating due to the action of gravity. In the case of implementing the present disclosure, the phases of the intermediate side first protrusion and the intermediate side second protrusion in the circumferential direction can be freely set. Specifically, for example, as shown in the sixth example of the embodiment shown in FIGS. 14 and 15 to be described later, the phases of the intermediate side first protrusion and the intermediate side second protrusion in the circumferential direction may be made to match with each other, or the intermediate side first protrusion and the intermediate side second protrusion may be arranged to be out of phase with each other by 90 degrees in the circumferential direction.

Further, in this example, the first protrusion 17, the second protrusion 21, the intermediate side first protrusion 33, and the intermediate side second protrusion 34 all have a sector-shaped end surface when viewed from the axial direction. Therefore, a contact area between the first protrusion 17 and the intermediate side first protrusion 33 and a contact area between the second protrusion 21 and the intermediate side second protrusion 34 are increased, and the contact surface pressure can be kept low. On the other hand, Patent Literature 2 does not describe or suggest specific shapes of engaging pieces 13a to 16a and 14b to 17b.

In this example, the first member 14 is coupled and fixed to the steering shaft 9 that rotates during use, and the second member 15 is coupled and fixed to the steering column 8 that does not rotate even during use. When implementing the present disclosure, the second member may be coupled and fixed to a rotation member that rotates during use, and the first member may be coupled and fixed to a fixed member that does not rotate even during use.

When implementing the present disclosure, materials for the first member, the second member, and the intermediate member are not particularly limited as long as they are capable of rotating (sliding) relative to each other, and may be made of, for example, a synthetic resin or a metal material. The first member, the second member, and the intermediate member constructed as a single unit or may be constructed by combining a plurality of components. When a member is constructed by combining a plurality of components, for example, a protrusion and a portion other than the protrusion may be made of different materials. If the first protrusion and the intermediate side first protrusion are made of different metal materials, adhesion between the first protrusion and the intermediate side first protrusion can be prevented. If the second protrusion and the intermediate side second protrusion are made of different metal materials, adhesion between the second protrusion and the intermediate side second protrusion can be prevented. Further, if the protrusion is made of a synthetic resin, collision noise can be reduced.

In terms of preventing adhesion and seizure of the first member, the second member, and the intermediate member, it is desirable to fill a cylindrical space between the outer peripheral surface of the first cylindrical portion of the first member and the inner peripheral surface of the second cylindrical portion of the second member with a lubricant such as grease. In this case, an oil seal may be provided between the first cylindrical portion of the first member, and the second flange portion and/or the blocking plate portion of the second member.

In this example, the rotation limiting device 4 is incorporated in the steering unit 3 constituting the steer-by-wire type steering device 1. Alternatively, the rotation limiting device according to the present disclosure may be incorporated and used to limit a rotatable amount of a rotation member of any rotating machinery device including not only the steer-by-wire type steering device, but also a steering device in which a steering unit and a steered unit are mechanically connected.

Further, in the rotation limiting device 4 according to the present example, the intermediate member 16 includes the intermediate side first protrusion 33 protruding from the axial other side surface of the side plate portion 32 toward the axial other side, and the intermediate side second protrusion 34 protruding from the axial one side surface of the side plate portion 32 toward the axial one side.

On the other hand, Patent Literature 2 discloses that the idle rotors 14 to 16 have the engaging pieces 14a to 16a and 14b to 16b, but the multi-rotation limit mechanism of Patent Literature 2 is originally an device for detecting a rotational end of a rotation shaft, does not lock the rotation of the rotation shaft, and has a different configuration and function from the intermediate side first protrusion 33 and the intermediate side second protrusion 34 of the present disclosure.

Patent Literature 3 discloses a first engaging member 141 that is formed integrally with an intermediate engaging member 150 and extends in the axial direction. However, it is for preventing the occurrence of a striking sound when the first engaging member 141 comes into contact with first and second arms 161 and 162 of a biasing member 160, and has a different function from the intermediate side first protrusion 33 and the intermediate side second protrusion 34 of the present disclosure.

Patent Literature 4 discloses that a first contact portion 412 protruding from an integrated rotation portion 410 only in the axial one side is provided. However, a member protruding from the integrated rotation portion 410 in the axial other side is not disclosed.

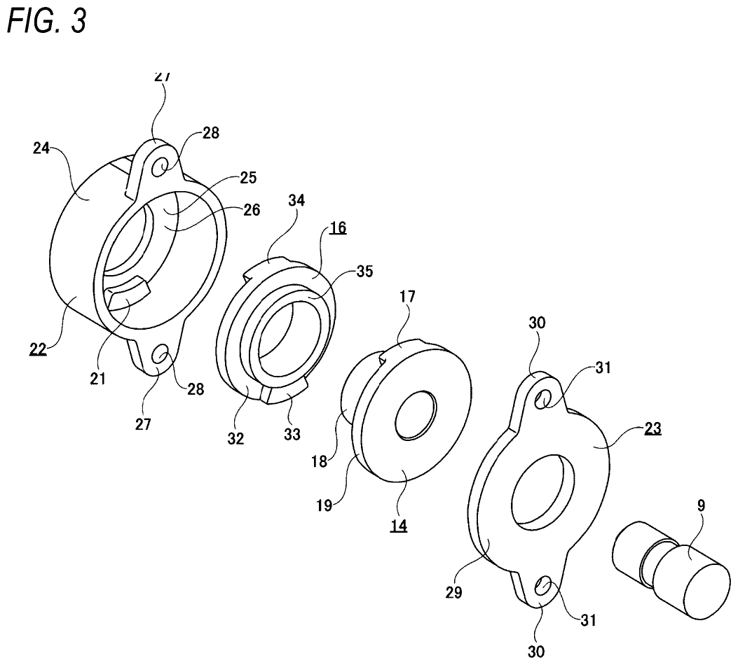

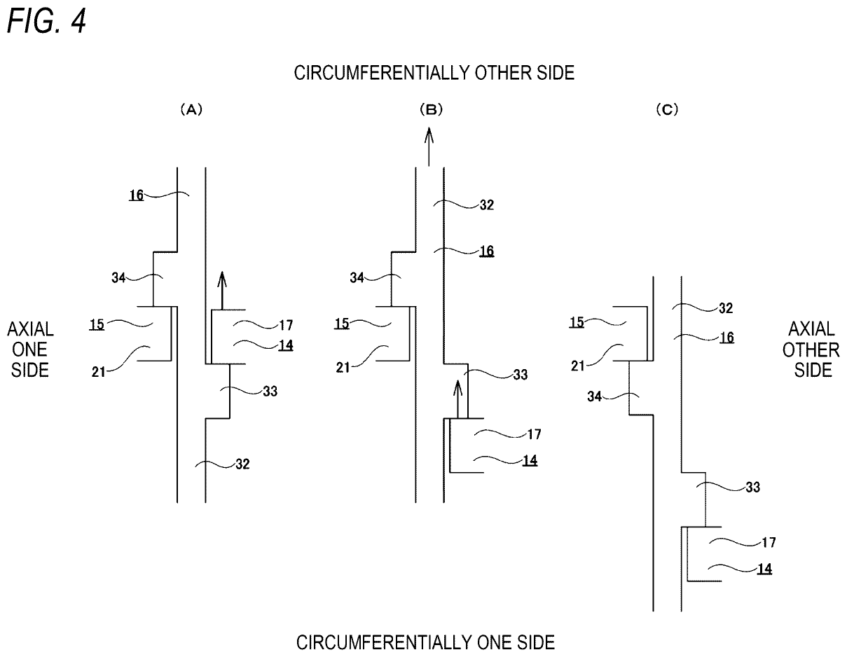

FIG. 8 of Patent Literature 5 discloses an outer peripheral support portion 175 formed so as to protrude to both sides in the axial direction of a second rotation member 170. However, the outer peripheral support portion 175 protrudes to the radially outer side from an outer peripheral side of the second rotation member 170. That is, since the outer peripheral support portion 175 is not located on the radially inner side of an outer peripheral surface of the second rotation member 170, it is disadvantageous in terms of compactness and strength. That is, if the outer peripheral support portion 175 repeatedly comes into contact with a first support portion 161 of a first rotation member 160 or an inner peripheral support portion 189 of a housing 180, the outer peripheral support portion 175 may be deformed or the outer peripheral support portion 175 may rotate as viewed from the radial direction. On the other hand, in the invention according to the present disclosure, the intermediate side first protrusion 33 and the intermediate side second protrusion 34 are formed integrally with the side plate portion 37, and do not protrude to the radially outer side from the side plate portion 37, so that the problem mentioned above is unlikely to occur. A third support portion 173 of the second rotation member 170 shown in FIG. 3 of Patent Literature 5 protrudes only in the axial one side, and is therefore different from the intermediate side first protrusion 33 and the intermediate side second protrusion 34 which protrude on both sides in the axial direction in the present disclosure.

### Second Example of Embodiment

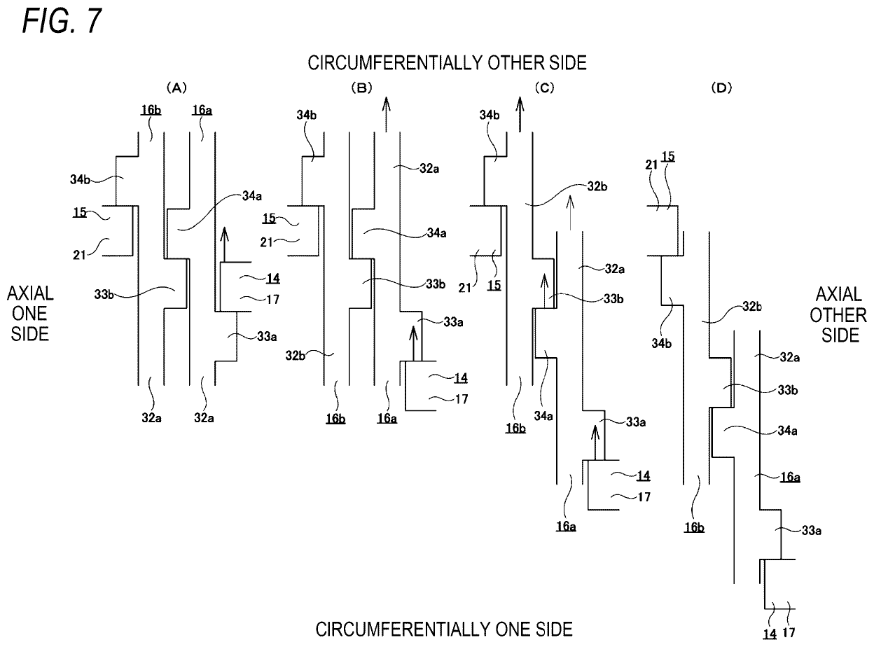

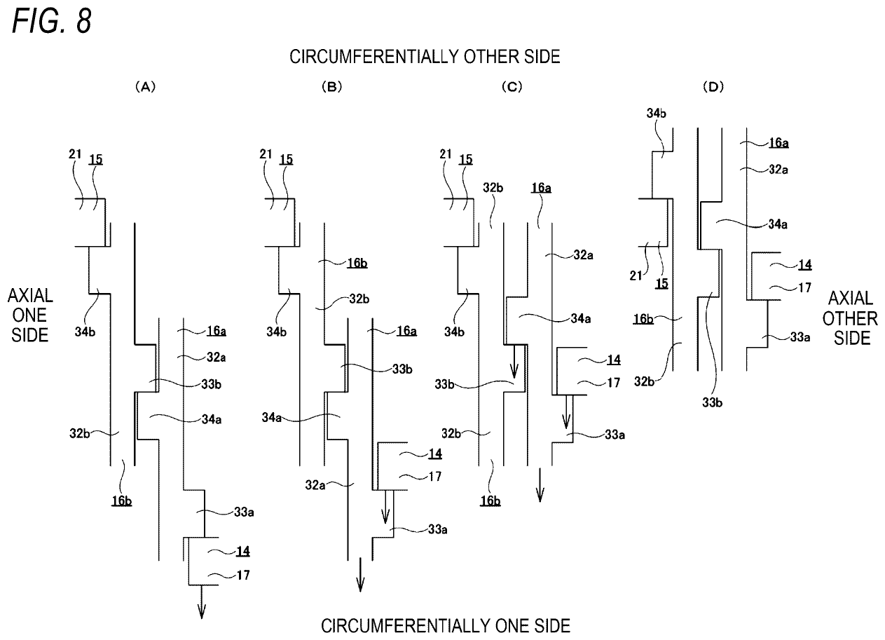

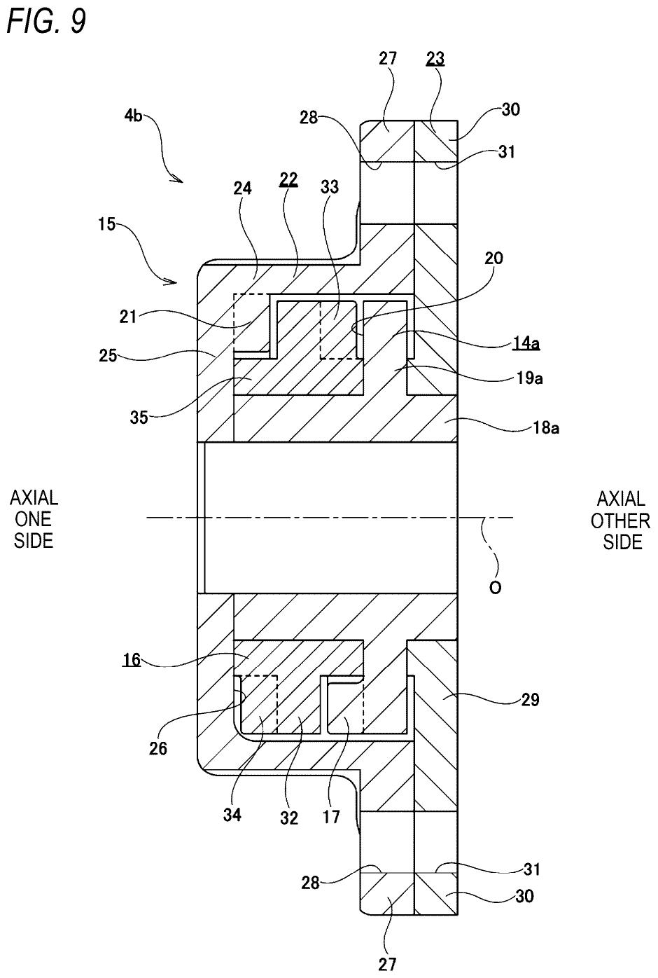

FIG. 9 shows a second example of the embodiment of the present disclosure. In a rotation limiting device 4b according to the present example, a first member 14a includes a first cylindrical portion 18a and a first flange portion 19a protruding toward the radially outer side from an outer peripheral surface of an intermediate portion of the first cylindrical portion 18a in the axial direction.

Then, the intermediate cylindrical portion 35 of the intermediate member 16 is externally fitted to an axial one side portion of the first cylindrical portion 18a in a relatively rotatable manner without rattling, and an axial other side portion of the first cylindrical portion 18a is internally fitted to the blocking plate portion 29 of the lid body 23 constituting the second member 15 in a relatively rotatable manner without rattling. That is, in this example, the first member 14 is positioned in the radial direction with respect to the second member 15 by internally fitting the axial other side portion of the first cylindrical portion 18a to the blocking plate portion 29 in a relatively rotatable manner without rattling. In addition, the end surface of the intermediate cylindrical portion 35 on the axial one side and an end surface of the first cylindrical portion 18a on the axial one side are brought into sliding contact or closely opposed to the radially inner side portion of the axial other side surface of the second flange portion 25 of the housing body 22 constituting the second member 15. That is, in this example, the first member 14 is positioned in the axial direction with respect to the second member 15 by bringing the end surface of the first cylindrical portion 18a on the axial one side into sliding contact or closely opposed to the radially inner side portion of the axial other side surface of the second flange portion 25.

The rotation limiting device 4b preferably includes a centering unit for ensuring coaxiality between the housing body 22a and the lid body 23. For example, the centering unit is constructed by spigot-fitting a convex portion provided on one of the housing body and the lid body with a concave portion provided on the other. Configurations and operation effects of other parts are the same as those of the first example of the embodiment.

### Third Example of Embodiment

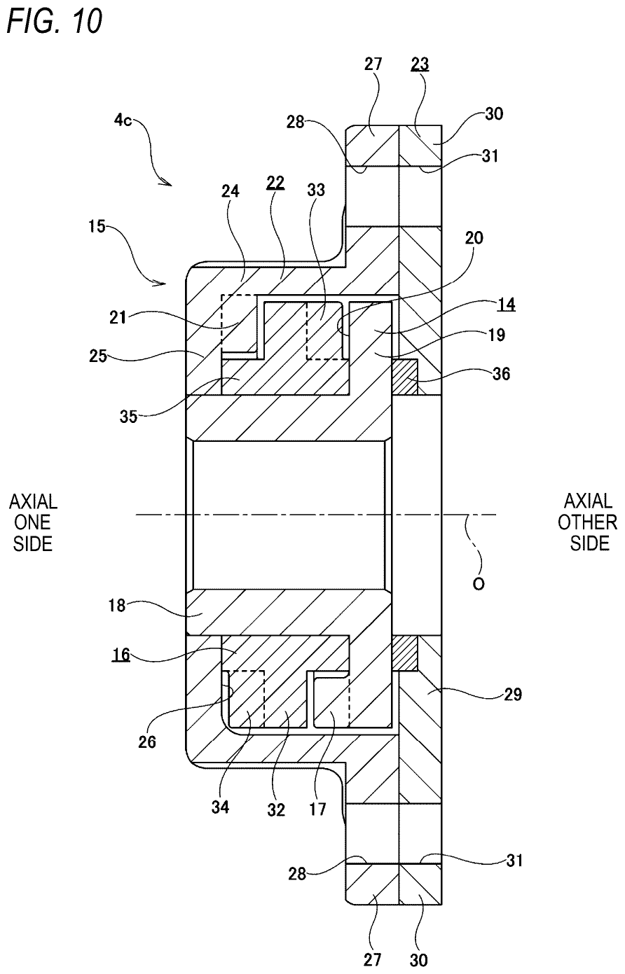

FIG. 10 shows a third example of the embodiment of the present disclosure. A rotation limiting device 4c according to the present example includes a preload applying member 36 that applies a preload in the axial direction between the first member 14 and the second member 15. The preload applying member 36 has a circular ring shape, and is elastically sandwiched between the axial other side surface of the first flange portion 19 of the first member 14 and the axial one side surface of the blocking plate portion 29 of the lid body 23 constituting the second member 15. Accordingly, a preload is applied between the first member 14 and the second member 15 in a direction in which the first protrusion 17 and the second protrusion 21 approach each other in the axial direction, that is, in a direction in which the first member 14 is pressed toward the axial one side with respect to the second member 15. The preload applying member 36 may be formed of, for example, a disc spring, a spacer made of a synthetic resin, or a combination of these.

According to the rotation limiting device 4c of the present example, rattling of the first member 14 relative to the second member 15 in the axial direction can be suppressed, and generation of abnormal noise can be prevented. Configurations and operation effects of other parts are the same as those of the first example of the embodiment.

### Fourth Example of Embodiment

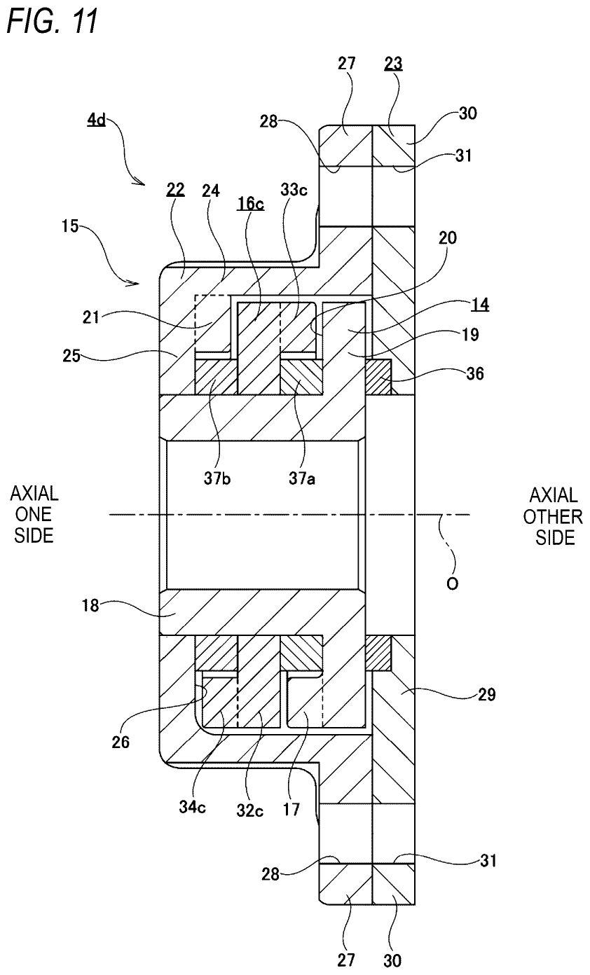

FIG. 11 shows a fourth example of the embodiment of the present disclosure. Similarly to the rotation limiting device 4c according to the third example of the embodiment, a rotation limiting device 4d according to the present example also includes the preload applying member 36 that applies a preload in the axial direction between the first member 14 and the second member 15. In this example, the preload applying member 36 is implemented by a disc spring, and is elastically sandwiched between the axial other side surface of the first flange portion 19 and the axial one side surface of the blocking plate portion 29. Accordingly, a preload is applied between the first member 14 and the second member 15 in a direction in which the first protrusion 17 and the second protrusion 21 approach each other in the axial direction.

In addition, in this example, an intermediate member 16c includes: a side plate portion 32c having a hollow circular plate shape; an intermediate side first protrusion 33c protruding toward the axial other side from an axial other side surface of the side plate portions 32c at one position in the circumferential direction; and an intermediate side second protrusion 34c protruding toward the axial one side from an axial one side surface at one position radially opposite to the intermediate side first protrusion 33c. The side plate portion 32c of the intermediate member 16c is externally fitted to the first cylindrical portion 18 of the first member 14 in a relatively rotatable manner without rattling.

The rotation limiting device 4d includes annular spacers 37a and 37b at a portion between an axial other side surface of the side plate portion 32c and the axial one side surface of the first flange portion 19 of the first member 14, and at a portion between an axial one side surface of the side plate portion 32c and the axial other side surface of the second flange portion 25 of the second member 15, respectively. As a result, rattling of the intermediate member 16c with respect to the first member 14 and the second member 15 in the axial direction is prevented, generation of abnormal noise is suppressed, and an increase in steering force caused by increased frictional resistance can be suppressed. Each of the spacers 37a, 37b is made of a material having a small friction coefficient with respect to the axial one side surface of the first flange portion 19 and the axial other side surface of the second flange portion 25, and/or the side plate portion 32c. Specifically, for example, each of the spacers 37a and 37b may be made of a resin washer, an oil-retaining metal, or the like.

According to the rotation limiting device 4d of this example, it is possible to prevent the rotational resistance between the first member 14 and the intermediate member 16c and the rotational resistance between the second member 15 and the intermediate member 16c from becoming unnecessarily large, while suppressing the rattling of the first member 14 with respect to the second member 15 in the axial direction.

That is, in the rotation limiting device 4c according to the third example of the embodiment, the preload applying member 36 applies a preload in a direction in which the first member 14 is pressed toward the axial one side with respect to the second member 15. Therefore, the intermediate cylindrical portion 35 of the intermediate member 16 is elastically sandwiched in the axial direction between the first flange portion 19 of the first member 14 and the second flange portion 25 of the second member 15, and there is a possibility the rotational resistance between the first member 14 and the intermediate member 16, and the rotational resistance between the second member 15 and the intermediate member 16 may increase.

On the other hand, in the rotation limiting device 4d according to the present example, the spacers 37a and 37b made of a material having a small friction coefficient against the first flange portion 19, the second flange portion 25, and/or the side plate portion 32c are disposed between the first flange portion 19 and the second flange portion 25 and the side plate portion 32c. Therefore, the rotational resistance between the first member 14 and the intermediate member 16 and the rotational resistance between the second member 15 and the intermediate member 16c can be prevented from becoming unnecessarily large, and relative rotation between the first member 14 and the intermediate member 16c and relative rotation between the second member 15 and the intermediate member 16c can be smoothly performed.

The positions of the preload applying member 36 and the spacers 37a, 37b may be interchanged. For example, a spacer may be disposed between the first flange portion and the lid body (blocking plate portion), and a preload applying member that exerts elastic force in the axial direction may be disposed between the first flange portion and the side plate portion and between the second flange portion and the side plate portion. In this case, for example, the preload applying member disposed between the first flange portion and the side plate portion may be implemented by disposing a disc spring between a pair of resin washers. Further, the preload applying member disposed between the second flange portion and the side plate portion may be implemented by disposing a disc spring between a metal washer on the axial one side and a resin washer on the axial other side. As a result, it is possible to prevent the rotational resistance between the first member and the second member and the intermediate member from becoming unnecessarily large, while providing the function of applying a preload between the first member and the second member. Configurations and operation effects of other parts are the same as those of the first example and the third example of the embodiment.

### Fifth Example of Embodiment

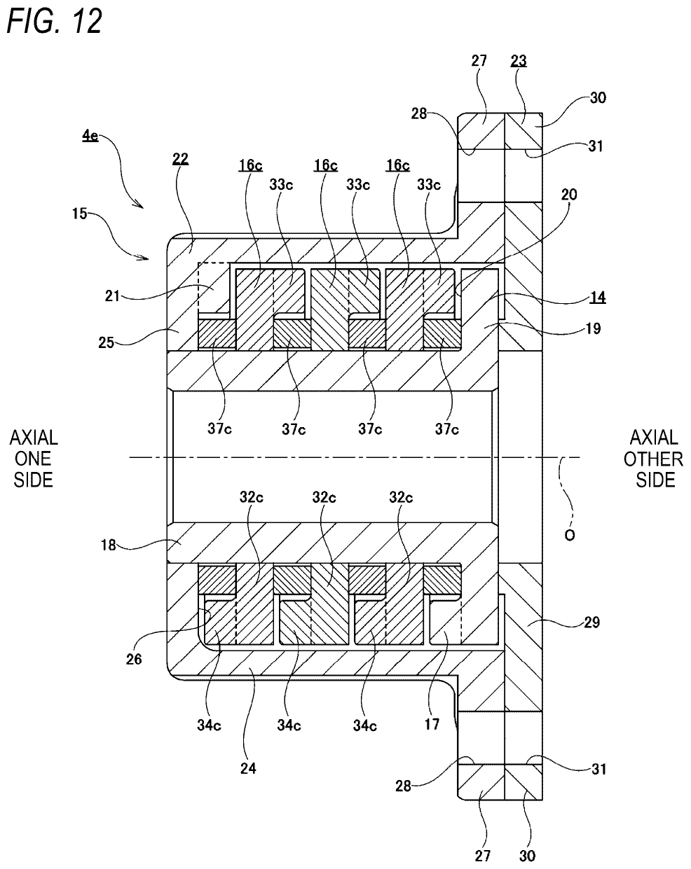

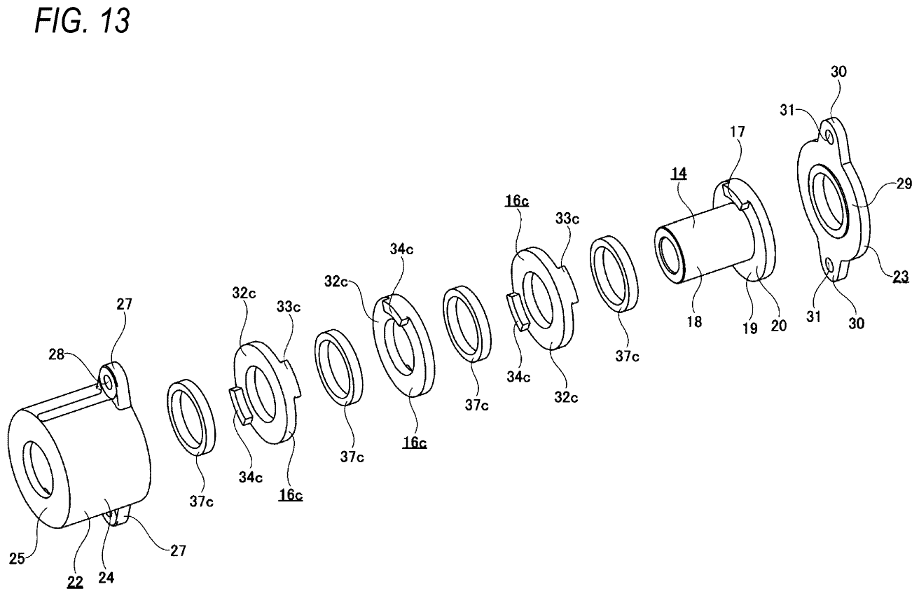

FIGS. 12 and 13 show a fifth example of the embodiment of the present disclosure. A rotation limiting device 4e according to the present example includes the first member 14, the second member 15, and three intermediate members 16c. All the intermediate members 16c have the same shape. In this example, each of the intermediate members 16c includes: the side plate portion 32c having a hollow circular plate shape; the intermediate side first protrusion 33c protruding toward the axial other side from an axial other side surface of the side plate portions 32c at one position in the circumferential direction; and the intermediate side second protrusion 34c protruding toward the axial one side from an axial one side surface at one position radially opposite to the intermediate side first protrusion 33c. The three intermediate members 16c are arranged in series in the axial direction and are externally fitted to the first cylindrical portion 18 of the first member 14 so as to be rotatable relative to each other. An axial length of the first cylindrical portion 18 and an axial length of the second cylindrical portion 24 are longer than that of the structure according to the first example of the embodiment by an amount of the intermediate members 16c added.

Further, the rotation limiting device 4e according to the present example includes four spacers 37c in portions between the three intermediate members 16c, a portion between the intermediate member 16c on the axial other side and the first flange portion 19, and a portion between the intermediate member 16c on the axial one side and the second flange portion 25, respectively. As a result, rattling of the three intermediate members 16c with respect to the first member 14 and the second member 15 in the axial direction is prevented, generation of abnormal noise is suppressed, and an increase in steering force caused by increased frictional resistance can be suppressed. Each of the spacers 37c is made of a material having a small friction coefficient with respect to the axial one side surface of the first flange portion 19 and the axial other side surface of the second flange portion 25, and/or the side plate portion 32c.

Since the rotation limiting device 4e according to the present example includes three intermediate members 16c, when the circumferential width of the first protrusion, the circumferential width of the second protrusion, the circumferential width of the intermediate side first protrusion, and the circumferential width of the intermediate side second protrusion are all 45 degrees, the rotatable amount of the steering shaft 9 (see FIG. 1) coupled and fixed to the first member 14 can be doubled as compared with the structure including only one intermediate member 16, such as in the rotation limiting device 4 according to the first example of the embodiment. Specifically, in the rotation limiting device 4e according to this example, when the circumferential width W of the first protrusion 17, the second protrusion 21, the intermediate side first protrusion 33c, and the intermediate side second protrusion 34c is all 45 degrees, the rotatable amount of the steering shaft 9 can be set to 1080 degrees.

In the rotation limiting device 4e according to this example, the three intermediate members 16c have the same shape. Therefore, it is possible to prevent an unnecessary increase in the manufacturing cost and the management cost of the parts and the assembling cost, and to suppress an increase in the manufacturing cost of the rotation limiting device 4e. Configurations and operation effects of other parts are the same as those of the first example and the modification thereof, and the third example of the embodiment.

### Sixth Example of Embodiment

FIGS. 14 and 15 show a sixth example of the embodiment of the present disclosure. A rotation limiting device 4f according to the present example includes the first member 14, the second member 15, and three intermediate members 16d. All the intermediate members 16d have the same shape. In this example, each of the intermediate members 16d includes: a side plate portion 32d having a hollow circular plate shape; an intermediate side first protrusion 33d protruding toward the axial other side from an axial other side surface of the side plate portions 32d at one position in the circumferential direction; and an intermediate side second protrusion 34d protruding toward the axial one side from an axial one side surface at one position coincident with the intermediate side first protrusion 33d in phase with respect to the circumferential direction. The three intermediate members 16d are arranged in series in the axial direction and are externally fitted to the first cylindrical portion 18 of the first member 14 so as to be rotatable relative to each other.

According to the rotation limiting device 4f of this example, it is possible to prevent a large force from being applied to the side plate portions 32d of the respective intermediate members 16d in the circumferential direction.

That is, for example, as in the rotation limiting device 4e according to the fifth example of the embodiment, in a structure in which the phases of the intermediate side first protrusion 33c and the intermediate side second protrusion 34c in the circumferential direction are different by 180 degrees, a force in the circumferential direction applied from the first protrusion 17 to the intermediate side first protrusion 33c is transmitted in the circumferential direction through the side plate portion 32c, and is applied to the second protrusion 21 from the intermediate side second protrusion 34c. Therefore, since a large force may be applied to the side plate portion 32c in the circumferential direction, it is necessary to ensure that the side plate portion 32c has a sufficient strength.

On the other hand, in the rotation limiting device 4f according to this example, the phases of the intermediate side first protrusion 33d and the intermediate side second protrusion 34d in the circumferential direction are made to match with each other. Therefore, most of the force in the circumferential direction applied from the first protrusion 17 to the intermediate side first protrusion 33d is directly transmitted to the intermediate side second protrusion 34d without acting on the side plate portion 32d, and is then applied to the second protrusion 21 from the intermediate side second protrusion 34d. As a result, a large force can be prevented from acting on the side plate portion 32d in the circumferential direction. Therefore, a thickness of the side plate portion 32d in the axial direction can be reduced, the intermediate side first protrusion 33d and the intermediate side second protrusion 34d can be made of a metal material, and the side plate portion 32d can be made of a synthetic resin, which makes it easier to reduce the weight of the intermediate member 16d. Configurations and operation effects of other parts are the same as those of the first example and the modifications thereof, the third example, and the fifth example of the embodiment.

### Seventh Example of Embodiment

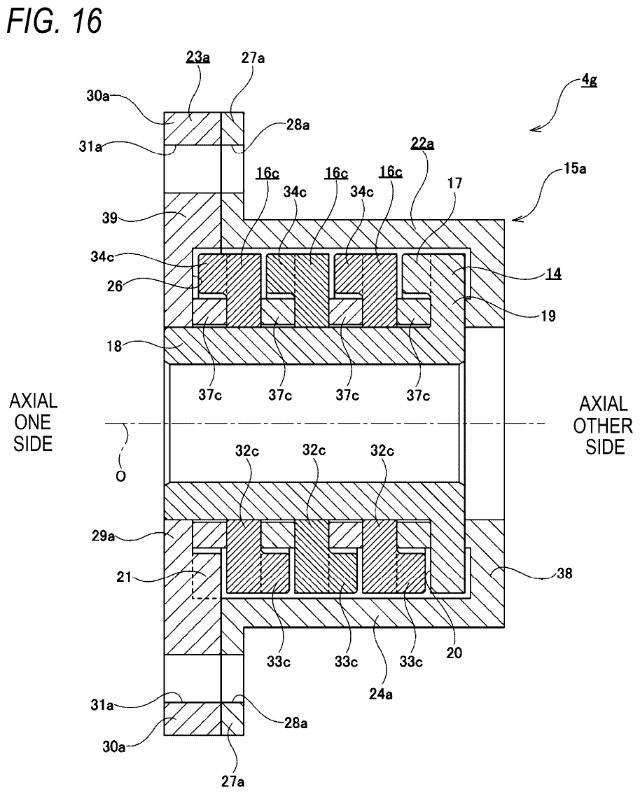

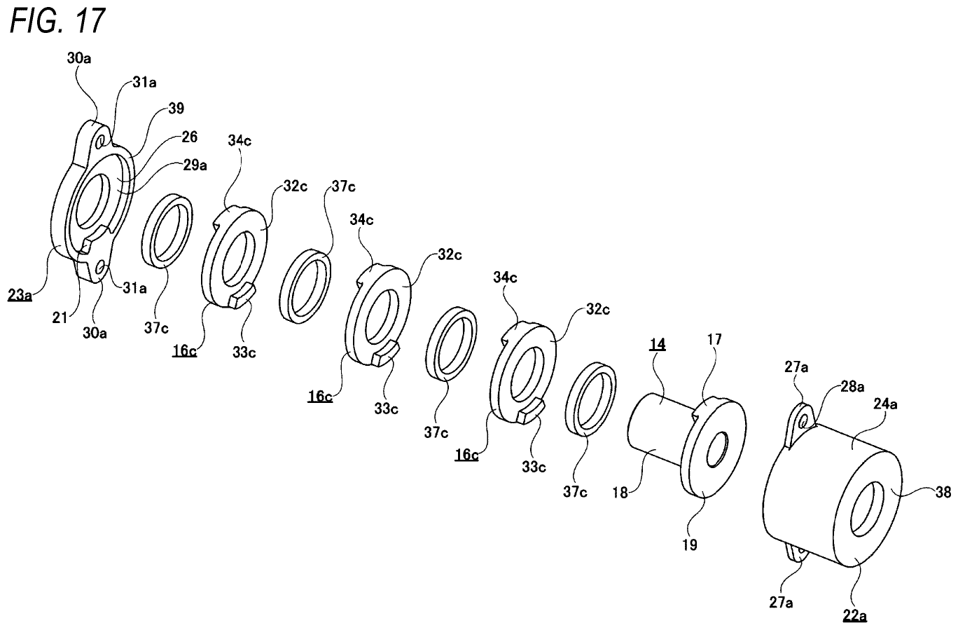

FIGS. 16 and 17 show a seventh example of the embodiment of the present disclosure. A rotation limiting device 4g according to the present example includes the first member 14, a second member 15a, and three intermediate members 16c. The second member 15a includes a housing body 22a and a lid body 23a.

The housing body 22a includes a second cylindrical portion 24a having a cylindrical shape, and an inward flange portion 38 having a hollow circular plate shape bent toward the radially inner side from an end portion of the second cylindrical portion 24a on the axial other side.

The housing body 22a further includes a pair of body side ear portions 27a protruding to the radially outer side from two radially opposite positions on an end portion of the second cylindrical portion 24a on the axial one side. Each of the body side ear portions 27a has a body side coupling hole 28a passing therethrough in the axial direction. In this example, the body side coupling hole 28a is formed as a cylindrical hole whose inside diameter does not change in the axial direction.

The lid body 23a covers (blocks) a radially outer side of an opening on the axial one side of the second cylindrical portion 24a of the housing body 22a. In this example, the lid body 23a includes a lid body cylindrical portion 39 having a cylindrical shape, and a blocking plate portion 29a in a hollow circular plate shape that protrudes toward the radially inner side from an axial one side portion of an inner peripheral surface of the lid body cylindrical portion 39.

An axial length of the lid body cylindrical portion 39 is sufficiently smaller than an axial length of the second cylindrical portion 24a since it is not necessary to arrange the plurality of intermediate members 16c in series on the radially inner side. For example, the axial length of the lid body cylindrical portion 39 is preferably ⅕ to 1/7 of the axial length of the second cylindrical portion 24a.

The blocking plate portion 29a has a second side surface 26 on the axial other side surface, and has the second protrusion 21 at one position in the circumferential direction of a radially outer side portion of the second side surface 26. An end portion of the second protrusion 21 on the radially outer side is connected to an axial other side portion of an inner peripheral surface of the lid body cylindrical portion 39. In this example, the axial other side surface of the second protrusion 21 is flush with an axial other side surface of the lid body cylindrical portion 39.

The lid body 23a has a pair of lid side ear portions 30a protruding toward the radially outer side from two radially opposite positions on an outer peripheral surface of the lid body cylindrical portion 39. Each of the lid side ear portions 30a has a lid side coupling hole 31a passing therethrough in the axial direction. In this example, the lid side coupling hole 31a is formed as a screw hole.

The pair of lid side ear portions 30a are overlapped with the pair of body side ear portions 27a on the axial one side, coupling bolts (not shown) are inserted into the pair of body side coupling holes 28a, and the coupling bolts are screwed into the pair of lid side coupling holes 31a, thereby coupling and fixing the housing body 22a and the lid body 23a.

The rotation limiting device 4g of the present example is supported and fixed to the steering column 8 that does not rotate even during use by screwing the coupling bolts into the column side screw holes that open in a front side surface of the steering column 8. That is, in this example, the axial one side (the left side in FIG. 16 and FIG. 17) corresponds to the rear side of the vehicle, and the axial other side (the right side in FIGS. 16 and 17) corresponds to the front side of the vehicle. The rotation limiting device 4g according to the present example may also be supported and fixed to the vehicle such that the axial one side faces the front side of the vehicle and the axial other side faces the rear side of the vehicle.

Each of the intermediate members 16c includes: the side plate portion 32c having a hollow circular plate shape; the intermediate side first protrusion 33c protruding toward the axial other side from an axial other side surface of the side plate portions 32c at one position in the circumferential direction; and the intermediate side second protrusion 34c protruding toward the axial one side from an axial one side surface at one position radially opposite to the intermediate side first protrusion 33c.

The rotation limiting device 4g according to this example is formed by combining the first member 14 and the three intermediate member 16c inside the second member 15a so as to be rotatable relative to each other. Specifically, the three intermediate members 16c are arranged in series and are externally fitted to the axial other side portion of the first cylindrical portion 18 of the first member 14 in a relatively rotatable manner without rattling, and the end portion of the first cylindrical portion 18 on the axial one side is internally fitted to the blocking plate portion 29a of the lid body 23a in a relatively rotatable manner without rattling.

The rotation limiting device 4g includes four spacers 37c in portions between the three intermediate members 16c, a portion between the intermediate member 16c on the axial other side and the first flange portion 19, and a portion between the intermediate member 16c on the axial one side and the blocking plate portion 29a, respectively. As a result, rattling of the three intermediate members 16c with respect to the first member 14 and the second member 15a in the axial direction is prevented.

According to the rotation limiting device 4g of this example, weight reduction and cost reduction can be achieved.

For example, in the rotation limiting device 4e according to the fifth example of the embodiment shown in FIGS. 12 and 13, the second protrusion 21, to which a force in the circumferential direction is applied in response to an operation on the steering wheel by a driver, is provided in the housing body 22 of the second member 15. The force in the circumferential direction applied to the second protrusion 21 is transmitted to the steering column 8 via the second flange portion 25, the second cylindrical portion 24, and the body side ear portion 27. Therefore, in the rotation limiting device 4e according to the fifth example, it is necessary to sufficiently secure the strength of the housing body 22 having the second cylindrical portion 24.

Here, since the second cylindrical portion 24 is disposed so as to cover the periphery of the plurality of intermediate members 16c arranged in series, it is necessary to increase the axial length to a certain extent. Therefore, if the thickness of the housing body 22 is increased in order to ensure the strength of the housing body 22, the weight of the second member 15 is increased, and thus the weight of the rotation limiting device 4e is increased.

In the rotation limiting device 4e according to the fifth example, the second protrusion 21 is provided on the second side surface 26, which is the axial other side surface of the second flange portion 25 that is bent toward the radially inner side from the end portion of the second cylindrical portion 24 on the axial one side. In other words, the second protrusion 21 is provided on the second side surface 26 that is located at an inner end portion of a cylindrical space that is radially inside the second cylindrical portion 24. For this reason, the processing of the second protrusion 21 is troublesome and the cost is increased.

On the other hand, in the rotation limiting device 4g according to this example, the second protrusion 21 is provided on the lid body 23a of the second member 15a. The force in the circumferential direction applied to the second protrusion 21 in response to the operation on the steering wheel by a driver is transmitted to the steering column 8 via the blocking plate portion 29a, the lid body cylindrical portion 39, and the lid side ear portion 30a. Since it is not necessary to cover the periphery of the plurality of intermediate members 16c arranged in series as the second cylindrical portion 24, the axial length of the lid body cylindrical portion 39 is sufficiently shorter than the axial length of the second cylindrical portion 24a. Accordingly, the weight of the second member 15a can be prevented from increasing excessively even if the thickness of the lid body 23a is secured in order to ensure the strength of the lid body 23a.

Further, since no force in the circumferential direction is applied to the housing body 22a, the housing body 22a can be made of a lightweight material such as a synthetic resin, or the thickness can be made thin even when the housing body 22a is made of a metal material. Therefore, according to this example, the weight of the second member 15a is easily reduced, and therefore the weight of the extension rotation limiting device 4g is easily reduced.

In this example, the second protrusion 21 is provided on the axial other side surface of the blocking plate portion 29a that protrudes toward the radially inner side from the axial one side portion of the inner peripheral surface of the lid body cylindrical portion 39. The axial length of the lid body cylindrical portion 39 is sufficiently shorter than the axial length of the second cylindrical portion 24a. As a result, a distance in the axial direction between the axial other side surface of the lid body cylindrical portion 39 and the axial other side surface of the second protrusion 21 can be reduced. Specifically, in this example, the axial other side surface of the second protrusion 21 is flush with an axial other side surface of the lid body cylindrical portion 39. Therefore, in the rotation limiting device 4g according to this example, the lid body 23a having the second protrusion 21 can be easily manufactured by press working or the like, and the cost can be kept low.

Configurations and operation effects of other parts are the same as those of the first example and the modification thereof, and the fifth example of the embodiment.

### Eighth Example of Embodiment

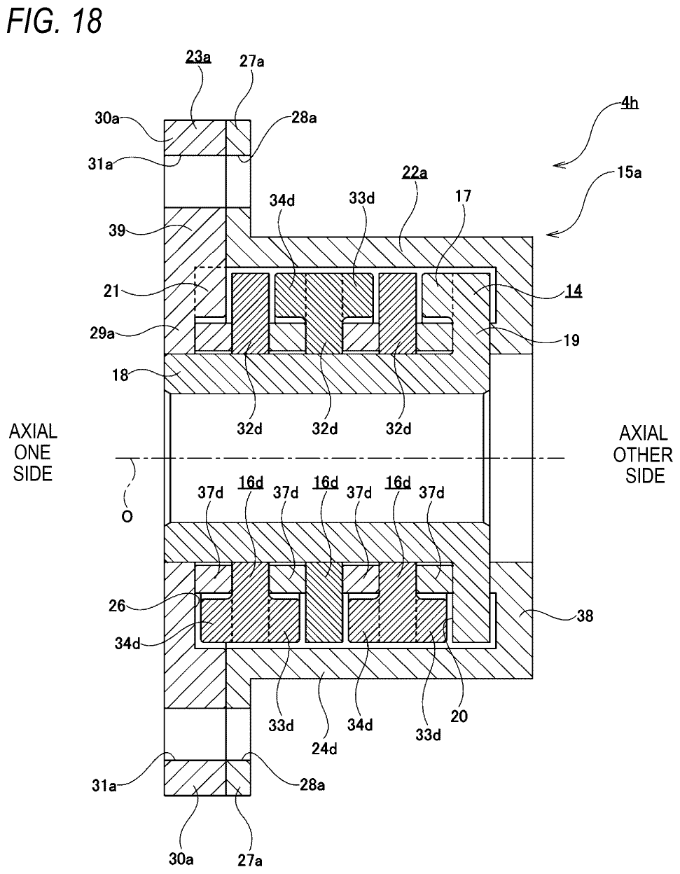

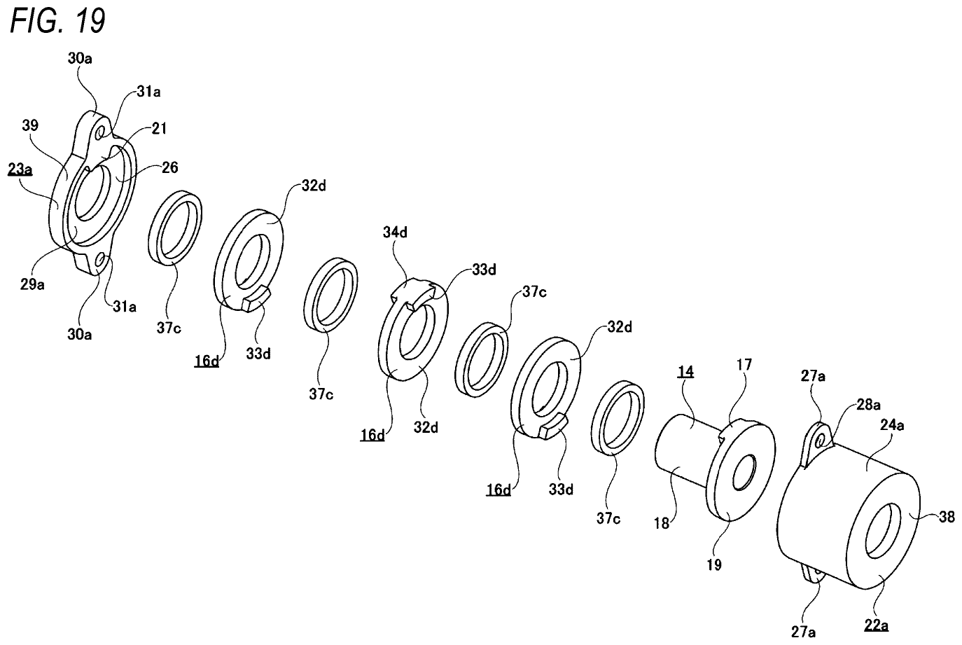

FIGS. 18 and 19 show an eighth example of the embodiment of the present disclosure. A rotation limiting device 4h according to this example has a structure that is a combination of the structure according to the sixth example of the embodiment shown in FIGS. 14 and 15 and the structure according to the seventh example of the embodiment shown in FIGS. 16 and 17. That is, the rotation limiting device 4h according to the present example includes the first member 14, the second member 15a, and three intermediate members 16d.

That is, the second member 15a is formed by joining and fixing the lid body 23a having the second protrusion 21, and the housing body 22a.

Each of the intermediate members 16d includes: the side plate portion 32d having a hollow circular plate shape; the intermediate side first protrusion 33d protruding toward the axial other side from the axial other side surface of the side plate portions 32d at one position in the circumferential direction; and the intermediate side second protrusion 34d protruding toward the axial one side from the axial one side surface at one position coincident with the intermediate side first protrusion 33d in phase with respect to the circumferential direction. The three intermediate members 16d are arranged in series in the axial direction and are externally fitted to the first cylindrical portion 18 of the first member 14 so as to be rotatable relative to each other.

Configurations and operation effects of other parts are the same as those of the first example and the modifications thereof, the sixth example, and the seventh example of the embodiment.

The present application is based on a Japanese Patent Application (No. 2022-015858) filed on Feb. 3, 2022 and a Japanese Patent Application (No. 2022-064765) filed on Apr. 8, 2022, the contents of which are incorporated herein by reference.

### REFERENCE SIGNS LIST

1 steering device
2 steering wheel
3 steering unit
4, 4a, 4b, 4c, 4d, 4e, 4f, 4g, 4h rotation limiting device
5 steered wheel
6 steered unit
7 control unit
8 steering column
9 steering shaft
10 reaction force applying device
11 gear housing
12 steering actuator
13 tie rod
14, 14a first member
15 second member
16, 16a, 16b, 16c, 16d intermediate member
17 first protrusion
18, 18a first cylindrical portion
19, 19a first flange portion
20 first side surface
21 second protrusion
22, 22a housing body
23, 23a lid body
24, 24a second cylindrical portion
25 second flange portion
26 second side surface
27, 27a body side ear portion
28, 28a body side coupling hole
29, 29a blocking plate portion
30, 30a lid side ear portion
31, 31a lid side coupling hole
32, 32a, 32b, 32c, 32d side plate portion
33, 33a, 33b, 33c, 33d intermediate side first protrusion
34, 34a, 34b, 34c, 34d intermediate side second protrusion
35 intermediate cylindrical portion
36 preload applying member
37a, 37b, 37c spacer
38 inward flange portion
39 lid body cylindrical portion
100 stopper unit
101 first rotation member
102 housing
103 second rotation member
104 first rotation protrusion
105 fixing protrusion
106 cylindrical portion
107 second rotation protrusion

1. A rotation limiting device comprising:
a first member having a first protrusion;
a second member having a second protrusion disposed on an axial one side with respect to the first protrusion, the second member being disposed coaxially with the first member and configured to rotate relative to the first member; and
at least one intermediate member supported in a relatively rotatable manner with respect to the first member and the second member, the at least one intermediate member including a side plate portion disposed between the first protrusion and the second protrusion in an axial direction, an intermediate side first protrusion protruding toward an axial other side from an axial other side surface of the side plate portion, and an intermediate side second protrusion protruding toward the axial one side from an axial one side surface of the side plate portion.

2. The rotation limiting device according to claim 1,
wherein the first member has a first side surface facing the axial one side and the first protrusion protruding from the first side surface toward the axial one side, and
wherein the second member has a second side surface facing the axial other side and the second protrusion protruding from the second side surface toward the axial other side.

3. The rotation limiting device according to claim 1,
wherein the first member is fitted radially inside the second member in a relatively rotatable manner, and
wherein the at least one intermediate member is disposed between the first member and the second member in a radial direction and is rotatable relative to the first member and the second member.

4. The rotation limiting device according to claim 3,
wherein the second member includes a second cylindrical portion disposed on a radially outer side of the first member and the at least one intermediate member.

5. The rotation limiting device according to claim 4,
wherein the first member has a first side surface facing the axial one side and the first protrusion protruding from the first side surface toward the axial one side,
wherein the second member has a second side surface facing the axial other side and the second protrusion protruding from the second side surface toward the axial other side,
wherein the second member has a second flange portion bent toward a radially inner side from an end portion of the second cylindrical portion on the axial one side, and
wherein the second flange portion has the second side surface on an axial other side surface.

6. The rotation limiting device according to claim 5,
wherein the second member includes
a housing body having the second cylindrical portion and the second flange portion, and
a lid body covering a radially outer side portion of an opening portion of the second cylindrical portion on the axial other side.

7. The rotation limiting device according to claim 6,
wherein the housing body has a body side coupling hole,
wherein the lid body has a lid side coupling hole,
wherein one coupling hole of the body side coupling hole and the lid side coupling hole is a screw hole, and the other coupling hole of the body side coupling hole and the lid side coupling hole is a screw hole or a cylindrical hole, and
wherein a coupling bolt is screwed or inserted into the other coupling hole and screwed into the one coupling hole.

8. The rotation limiting device according to claim 4,
wherein the first member has a first side surface facing the axial one side and the first protrusion protruding from the first side surface toward the axial one side,
wherein the second member has a second side surface facing the axial other side and the second protrusion protruding from the second side surface toward the axial other side,
wherein the second member includes
a housing body including the second cylindrical portion and an inward flange portion bent toward a radially inner side from an end portion of the second cylindrical portion on the axial other side, and
a lid body covering a radially outer side portion of an opening portion of the second cylindrical portion on the axial one side, and
wherein the lid body has the second side surface on an axial other side surface.

9. The rotation limiting device according to claim 8,
wherein the housing body has a body side coupling hole,
wherein the lid body has a lid side coupling hole,
wherein one coupling hole of the body side coupling hole and the lid side coupling hole is a screw hole, the other coupling hole of the body side coupling hole and the lid side coupling hole is a screw hole or a cylindrical hole, and
wherein a coupling bolt is screwed or inserted into the other coupling hole and screwed into the one coupling hole.

10. The rotation limiting device according to claim 2,
wherein the first member includes a first cylindrical portion to which the at least one intermediate member is externally fitted in a relatively rotatable manner, and a first flange portion that protrudes toward a radially outer side from an outer peripheral surface of the first cylindrical portion, and
wherein the first flange portion has the first side surface on an axial one side surface.

11. The rotation limiting device according to claim 1, further comprising:
a preload applying member configured to apply a preload in the axial direction between the first member and the second member.

12. A steering device comprising:
a steering shaft; and
a rotation limiting device configured to limit a rotatable amount of the steering shaft to a predetermined value,
wherein the rotation limiting device is implemented by the rotation limiting device according to claim 1, and
wherein one member of the first member and the second member is coupled and fixed to the steering shaft, and the other member of the first member and the second member is supported and fixed to a portion that does not rotate even during use.
